(19) United States
(12) Patent Application Publication
(10) Pub. No.: US 2016/0070864 A1
(43) Pub. Date: Mar. 10, 2016

(54) HEALTHCARE HAZARD DETECTION AND EARLY WARNING SYSTEM

(71) Applicants: Douglas Bernard Dotan, Bellaire, TX (US); Noah Harris Smith, College Station, TX (US)

(72) Inventors: Douglas Bernard Dotan, Bellaire, TX (US); Noah Harris Smith, College Station, TX (US)

(21) Appl. No.: 14/848,076

(22) Filed: Sep. 8, 2015

Related U.S. Application Data
(60) Provisional application No. 62/047,483, filed on Sep. 8, 2014.

(51) Int. Cl. G06F 19/00

(52) U.S. Cl. CPC G06F 19/322; G06F 19/326

(57) ABSTRACT

A patient safety system receives remote inputs wirelessly transmitted by a mobile device over a wireless network referred to herein as a patient safety network. The remote inputs indicate information, obtained by the patient safety application, pertaining to a patient safety event. Responsive to receiving remote input indicating a patient safety event category, the patient safety system creates a patient safety data record, comprising a set of predefined fields, corresponding to the patient safety event. In one non-limiting application applicable to patient safety events defined in the AHRQ Common Formats, the mobile device user may initiate the generation of a patient safety database record simply by selecting from a mobile device user interface one of nine patient safety event types defined by the Common Formats and one of three patient safety event levels of severity defined by the Common Formats.

### RELATED APPLICATION

This non-provisional application claims the benefit of U.S. Provisional Application No. 62/047,483, filed Sep. 08, 2014, entitled Healthcare Hazard Detection and Early Warning System, which is incorporated by reference herein in its entirety.

### BACKGROUND

1. Field of the Disclosure

Disclosed subject matter relates to healthcare systems and practices and more particularly to systems and practices for generating, collecting, analyzing, and reporting events that pertain to patient safety.

2. Description of the Related Art

Preventable medical errors, including improperly administered medications and other medical products and services, patient accidents occurring in hospital and other healthcare facilities, and similar types of events, cause or contribute to many fatalities and injuries each year. A 1999 report from the Institute of Medicine entitled To Err is Human estimated that, in the U.S. alone, the number of hospital fatalities resulting from preventable medical errors was at least 44,000 annually.

The significance of the preventable medical error problem motivated the U.S. government to enact the Patient Safety and Quality Improvement Act (PSQIA) of 2005 to establish systems and procedures for reporting patient safety events, including standards defining nine specific types of frequently occurring events and three levels of severity applicable to all event types, and regulations and protocols for reporting medical events to external agencies and boards.

Compliance with PSQIA provisions is largely voluntary. The general idea behind voluntary reporting is that providers will be motivated and more likely to report patient safety events and more likely to report events timely and accurately when they have a level of assurance that the information will not be used to establish provider liability or to otherwise punish the provider.

To encourage participation, the PSQIA proscribes, with only a small number of specifically-defined exceptions, the disclosure of patient safety work product (PSWP), which is broadly defined as encompassing any data, reports, records, memoranda, analyses, and statements, whether written or oral, that could improve patient safety, health care quality, or health care outcomes, that are assembled or developed by a provider for reporting to a Patient Safety Organization (PSO), and that are reported to a PSO.

The PSQIA includes provisions requiring the redaction, from any medical records that are a part of PSWP, of information identifying a specific individual, but permits the disclosure of PSWP that is non-identifiable as defined by the PSQIA. The PSQIA also specifically defines certain data as not being PSWP, including medical records of individual patients, billing and discharge information, any information indicating the original patient or provider, and any information collected, maintained, or developed separately, or existing separately, from a patient safety evaluation system.

Accordingly, the PSQIA and other regulations establish a complex rubric for maintaining information that is extremely private, but is also capable of resulting in patient safety improvements having a potentially enormous beneficial impact.

### BRIEF DESCRIPTION OF THE DRAWINGS

FIG. 1 illustrates elements of a content delivery network;

FIG. 2 illustrates elements of a head-end office in the network of FIG. 1;

FIG. 3 illustrates elements of a multimedia processing method; and

FIG. 4 illustrates elements of a multimedia router and processor;

FIG. 5-FIG. 12 illustrate elements of various method of using the patient safety platform;

FIGS. 13-FIG. 18 illustrate selected user interfaces of the patient safety application on the mobile devices;

FIGS. 19-29 illustrate selected user interfaces of the patient safety system; and

FIG. 30 illustrates features of an embodiment of the patient safety database.

### DESCRIPTION OF EMBODIMENTS

Subject matter included herein discloses a method for documenting patient safety events and maintaining a patient safety database. The method may be performed by a patient safety system that encompasses a patient safety database management system and one more supporting servers. The patient safety system may provide a patient safety application to a mobile device, either directly from a web site of the patient safety application provider or via download from a third party portal (e.g., a patient safety application portal or web site of a mobile device supplier). The following description of a patient safety method and system, unless expressly indicated otherwise, describes features included in at least one embodiment, sometimes referred to as an exemplary embodiment, rather than features required in all embodiments.

In an exemplary embodiment, the patient safety system receives remote inputs wirelessly transmitted by a patient safety application of a smart phone or other type of wireless device over a wireless network referred to herein as a patient safety network. The remote inputs indicate information, obtained by the patient safety application, pertaining to a patient safety event. Responsive to receiving remote input indicating a patient safety event category, the patient safety system creates a patient safety data record, comprising a set of predefined fields, corresponding to the patient safety event. In one non-limiting application applicable to patient safety events defined in the Common Formats from the Agency for Healthcare Quality and Research (AHRQ), the mobile device user may initiate the generation of a patient safety database record simply by selecting, from a mobile device user interface one of nine patient safety event types defined by the Common Formats and one of three patient safety event levels of severity defined by the Common Formats.

The set of predefined fields may reflect the schema or organization of the patient safety database and may be intended to preserve, at a minimum, fields required or requested by any statutory PSO. In addition, however, the patient safety database design supports proprietary functionality encompassing the ability to display and modify individual records in the patient safety database, search and filter records in the patient safety database, and present graphical and statistical representations and summaries of records in the patient safety database filtered according to any one or more of a wide range of criteria.

Once a patient safety category is defined, the patient safety application presents the user with a sequence or set of user interface fields appropriate to the particular patient safety event category and the mobile device user provides inputs corresponding to one or more fields. The mobile device wirelessly transmits one or more remote inputs indicative of the inputs provided to the various fields. Responsive to receiving these remote inputs from the mobile device, the patient safety system automatically populates at least some of the patient safety data record fields with values determined in accordance with the subsequent remote input. After the mobile device user provides information for at least a minimum set of fields and indicates that completion of the input process, the patient safety system may store the patient safety data record in a patient safety database.

The patient safety system may utilize the patient safety database for various distinct purposes. In response to a first type of input from a patient safety system user, sometimes referred to herein as an administrator or manager, indicating a particular patient safety record, after verifying the user's access rights, the patient safety system may provide at least some of the fields in the particular patient safety record in a first output format suitable for inclusion within a user interface displayed to the user, enabling the system user to view patient safety records and information stored therein. The patient safety system user may interact with the user interface to modify one or more fields of the patient safety data record. An administrative database, distinct from the patient safety database, may determine specific access rights and privileges of specific system users.

The patient safety system recognizes a second type of administrator input that indicates filtering criteria, e.g., records pertaining to a particular patient safety event type, patient, facility, date or range of dates, etc. The patient safety system may filter the patient safety database in accordance with the criteria to obtain a subset of patient safety data records in the patient safety database. The patient safety system may then present at least some of the fields of the subset in the first output format for inclusion within a listing user interface displayed to the user and display a statistical summary of the subset.

The patient safety system may also recognize a system user input identifying a particular patient safety data record for reporting to an external agency or other third party. In the example of an AHRQ PSO, the system user may identify a patient safety data record constituting PSWP eligible for reporting to the PSO. In response to receiving this type of input, the patient safety system may present, to a patient safety event reporting module within the patient safety system or accessible to the patient safety system as an outside resource, at least some of the fields of the particular patient safety data record in a second output format suitable for inclusion within a patient safety event report format specified by the third party.

The patient safety application supports various types of inputs, including non-textual inputs, i.e., inputs requiring no typing by the mobile device user, and, accordingly, sends various types of remote inputs to the patient safety system over the patient safety network. The input types that the patient safety system may receive as the remote inputs include, as non-limiting examples, voice inputs indicative of voice information provided to the patient safety application by a microphone of the mobile device, bar code inputs, indicative of bar code information corresponding to an image of a bar code provided to the patient safety application by a camera of the mobile device, radio frequency inputs, indicative of a radio frequency identifier detected by the mobile device, and menu selection inputs indicative of a user interface menu object selected by the mobile device user.

In the case of voice inputs, the patient safety application may send a voice or audio file to the patient safety system, in which case, the patient safety system may access a speech-to-text processing module, whether internal to or accessible to the patient safety system as an outside processing resource, to obtain a textual transcription of the speech and include the textual translation in the voice input.

In the case of bar code inputs, the patient safety system may provide the bar code information to an external database and obtaining records associated with the bar code information from the external database. For example, in the case of a bar code identifying a medication, the patient safety system may access an externally maintained prescription medicine database and obtain records indicating various dosage regimens approved for various forms of the medication. The patient safety system may provide this information to the patient safety application, in which case the patient safety application may present the various alternative as a drop down menu that the mobile device user may use when providing information for a medication field.

In the case of a bar code identifying a patient, the patient safety system may access a master patient database, such as a master patient indexer, to retrieve patient information. In addition, the patient safety system may retrieve additional records, including electronic health records, from one or more electronic health records databases. A bar code input might also identify a medical device or a piece of medical equipment used in conjunction with services provided to the patient, in which case, the patient safety system may access an external database to obtain information regarding operation, maintenance, or other aspects of the medical device.

The patient safety application also supports image and video inputs indicative of an image or video captured by or stored in the mobile device, enabling a care provider, for example, to include a picture or video of the scene of a patient fall, a specific piece of medical equipment, etc. to the patient safety system, which may then include the image(s) and/or video(s) as an a narrative, supplement, or attachment to the applicable patient safety data record.

The patient safety system may also support a peer review process initiated in response to a fourth type of system user input, in which case, the patient safety system may provide a particular patient safety data record to a peer review group, responsive to peer review group input, include peer review findings and recommendations within corresponding fields of the patient safety data record.

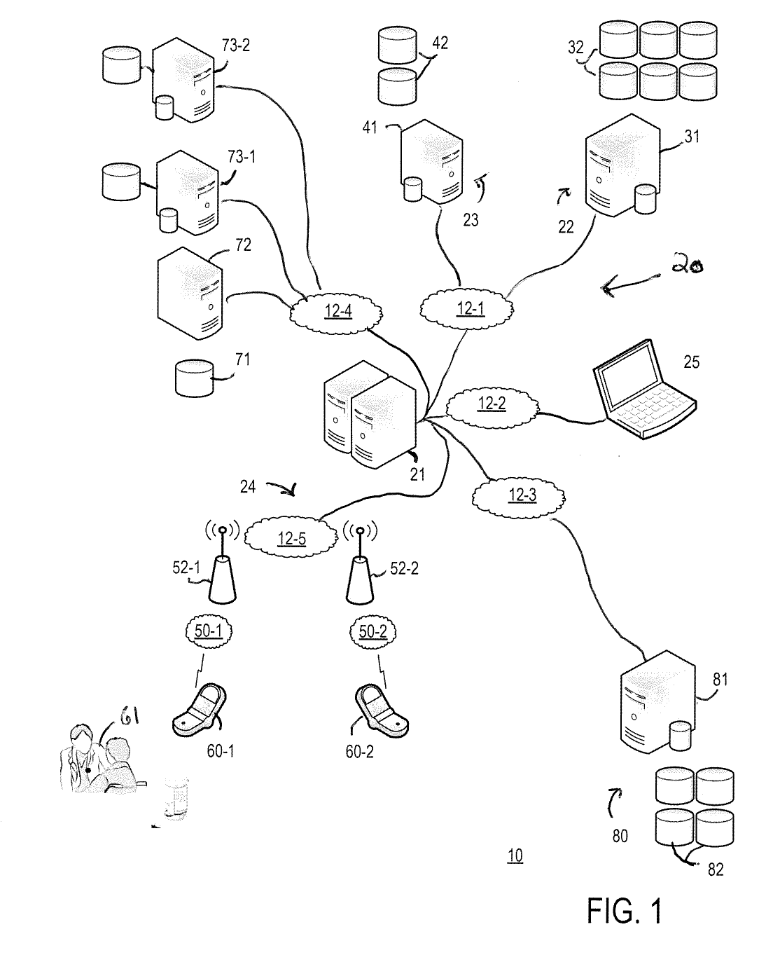

FIG. 1 illustrates an exemplary patient safety platform 10 that supports and facilities the generation and management of patient safety data documenting, at a minimum, occurrences of any of a well-defined set of patient safety events including patient fall events, improper medication events, and other preventable medical errors that occur frequently in health care facilities.

The disclosed patient safety platform beneficially addresses patient safety challenge, more specifically, patient safety mitigation challenges, that are pervasive throughout the health care field with features that embedded in technical features of the platform disclosed herein. For example, patient safety is a broad term that encompasses private and public efforts designed to document and quantify patient safety events as a part of a strategy to reduce the number of preventable medical errors that occur by identifying and modifying or eliminating any practices, procedures, systems, or devices, that cause or contribute to preventable medical errors. Legislative programs and standards, including the Common Formats, support the generation of a patient safety database reflecting patient safety data for a small and well-defined set of frequently occurring patient safety event types across a broad spectrum of health care facilities in different geographic regions servicing patients with varying demographics. In order to achieve some degree of uniformity among the organizations reporting patient safety data, the standardized categories of patient safety event types are, perhaps necessarily, defined in a way that may be under inclusive or too inflexible for other purposes, including private party programs maintained by specific health care facilities, providers, insurers, PSOs, and so forth.

In addition, to encourage health care institutions and care providers to report patient safety data consistently and in a timely manner against a well-documented historical reluctance within the industry to acknowledge errors and omissions, governmental-backed patient safety efforts have been largely voluntary in terms of compliance and have provided concrete assurances against the use of voluntarily reported patient safety data for purposes of determining professional or civil liability for preventable medical patient safety injuries and deaths. The definition of PSWP, for example, except any data that identifies an individual patient or individual care provider from mandatory reporting requirements. In this context, health care facilities have had to weigh the benefits of pursuing two separate patient safety monitoring programs and the associated costs of maintaining two patient safety database systems against the potential cost of patient safety events that may have been prevented under a more expansive monitoring and reporting program.

However, the potentially enormous social and monetary benefits accompanying even modest reductions in patient safety events motivates at least some health care facilities to pursue patient safety monitoring and reporting programs that expand upon governmental programs, whether to maintain data that may be used to identify correlations between patient safety events and individual care providers and/or patients, to track categories of patient safety that may not correlate to any single standard patient safety event type.

Embodiments of subject matter disclosed herein address and resolve this conflict by implementing a transformation agnostic patient safety database schema promotes lossless translation of data values into different output formats that may be suitable or tailored for different applications including, as not limiting examples, HTML applications suitable for providing human viewable representations of patient safety data records and summaries of selected subsets of the patient safety data records as well as “export” applications in which patient safety data records are packaged for delivery to a PSO or other external recipient according to potentially rigid formatting mandated by the recipient.

In at least one embodiment, the patient safety database employs a form database schema in which the values of the form answer sets are held as individual records, as opposed to being held in fields. A set of answers for a field may be reconstructed by a relationship between a primary event record identification number, which may be stored as a meta-data field in each of the answers.

Many form fields are defined as storing answers from pre-defined answer sets, which are stored in the database schema in a tree structure. To the extent possible, the answers stored in each record of the form data comprise references to tree-data structure keys. Moreover, the answer set tree structure may be held in the same table as the form answers (field sets), such that structurally within the schema, there is no formal difference between pre-defined answer trees and free-text or pre-defined answers stored as answer data to a specific instance of the form. The result is that the answer sets to the specific fields of a subset of the form answers also stands as its own answer set tree for population within other fields to the same form or other forms.

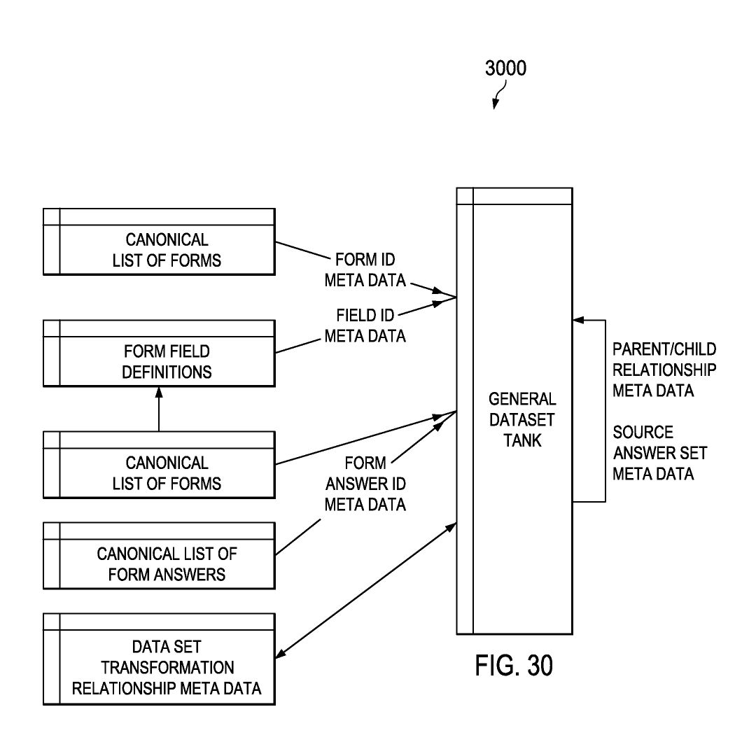

In this design, answer sets for a form may be reconstructed by referencing the meta-data primary key of the form answer (a numeric key). Answer set trees may be reconstructed in the same manner, except that they may respect the parent-child relationship meta-data for the answers. Similarly, answer set trees (typically, a flat tree or list), can be constructed by querying similar fields from across several form answers, by referencing the form-field key meta data. In the same manner, cross-tab analysis and aggregate analysis can be used by grouping and counting answers across the answer records which share either the same form field meta-data, or the same answer set tree meta data keys (so, unrelated fields between form answers can be compared if they share the same answer set tree meta data keys). Additionally, transformations between answer set tree data sets may be stored, which allows aggregation, comparison, or cross-tab filtering between different answer set data trees by transforming the keys of one answer set tree into another using the relationship meta data. Aspects of these features of a patient safety database are illustrated in FIG. 30.

The patient safety platform 10 illustrated in FIG. 1 employs an mobile device application, referred to herein as the patient safety application, configured to execute on a mobile device such as a smartphone or a tablet device of a doctor, nurse, or another care provider, to enable care providers to document, often without having to input any textual information, details pertaining to a preventable medical accident also referred to herein as a patient safety event, and to create, from a remote location, a record corresponding to a particular patient safety event in a patient safety database. In at least one embodiment suitable for implementations that leverage the patient safety database for multiple and potentially different types of outputs and applications.

The patient safety database may employ an architecture or schema that can be characterized as transformation agnostic. In at least one embodiment, the patient safety database may hold values of the form answer sets as individual records, rather than fields so that a set of answers for a field may be reconstructed base on an event record identification number, which is stored may be stored as a meta-data field in each of the answers. In at least one embodiment, the agnostic structure of the database enables patient safety platform 10 to access, filter, and provide data from the database in applications expecting HTML compliant data values including web browsers and applications expecting XML or XML-like data structures conforming to a structure defined by the recipient.

The patient safety platform 10 illustrated in FIG. 1 includes a patient safety system 20 that encompasses a patient safety server 21, a patient safety database 22, an administrative database 23, and a patient safety network 24, encompassing multiple health care facilities 52, two of which are illustrated in FIG. 1 as facilities 51-1 and 51-2, with remote mobile devices 60, each belonging to or otherwise associated with a corresponding doctor, nurse, technician, attendant, or other care provider employed by or associated with one or more of the health care facilities 51. Each of the mobile devices 60 may include a mobile device application program (not depicted in FIG. 1) referred to herein as a patient safety application that facilitates delivery of information pertaining to a patient safety event to patient safety System 20 and ensures the reliable creation of a record of the patient safety event in patient safety database 22.

Patient safety server 21 may provide various support functions including, as non-limiting examples, web server functions, communication functions, security functions, network management and configurations functions, and so forth. patient safety server 21 may also host or support a patient safety administrator interface that provides a web-accessible portal for administrator-level access to patient safety database 22 enabling an administrator with Internet access, represented in FIG. 1 by lap top 25, to view and modify patient safety database records, generate listings of patient safety database records, search and filter patient safety database 22, perform statistical analysis on and generate graphical representations of the patient safety database or selected subsets of the database, forward database records to peer review groups, input follow up data, generate trend lines, and perform other features.

The patient safety database 22 of FIG. 1 is illustrated as a database management system that includes a database management server 31 coupled to an array of database storage elements 32. Similarly, the administrative database 23 of FIG. 1 is also is illustrated as a database management system that includes a database management server 41 coupled to an array of database storage elements 42. In at least one embodiment, patient safety database 22 represents the repository of all patient safety data records associated with the patient safety platform 10 while administrative database 23 maintains data pertaining to database access rights including which individual users and which user groups are permitted access to which, if any, elements of patient safety database 22 and which, if any, features of a database management portal are accessible to which individual users or user groups.

FIG. 1 illustrates patient safety server 21 coupled to patient safety database 22 via an access network 12-1 which represents the physical media, network routers, gateways, firewalls and other network devices, and supporting firmware and software enabling communication. Access network 12-1, like other instances of access networks 12 illustrated in FIG. 1 may include various types of physical medium and may encompass public network portions, including the Internet, as well as private network portions and virtual private network portions. Computational resources illustrated in FIG. 1, including any database management resources, CPU resources, and storage resources, although depicted as tangible computer devices and data storage elements, may be implemented as virtual computational resources provided as one or more cloud computing services maintained by a third party.

The illustration of multiple access networks with which patient safety server 21 interfaces emphasizes distinctions in function and is not intended to preclude configurations or embodiments in which any two or more of the access networks 12 illustrated in FIG. 1 are implemented on a shared physical media, share a network interface connection, employ a common communication protocol stack, or otherwise share resources.

The patient safety platform 10 illustrated in FIG. 1 supports and facilitates the collection of information necessary to generate patient safety data records reflecting patient safety events occurring in any of the facilities 51 supported by patient safety platform 10. In at least one embodiment, care givers providing care to patients install a patient safety application provided by or available from patient safety server 21 for installation on their personal mobile devices 60 or other suitable mobile electronic device including, as a non-limiting example, tablet devices or dedicated or proprietary wireless devices. As discussed in additional detail and figures that follow, the patient safety applications installed on the mobile devices 60 enable care givers to initiate the creation of a patient safety data record corresponding to a patient safety event, often using input modalities that do not require the care giver to type or speak significant, if any, textual information. Instead, the care giver may initiate the creation of a patient safety data record by touching one or more selectable objects presented in user interfaces displayed by mobile device 60, by scanning a barcode to identify a patient, a medication or blood product administered to the patient, a medical device used on or in conjunction with care provided to the patient, or in any other suitable manner suitable in the context of patient care and patient safety.

In one non-limiting embodiment, a care giver, using the patient safety application, may wirelessly transmit, to patient safety system 20, a remote input that initiates the creation, by patient safety system 20, of a record in the patient safety database simply by selecting one or more touchscreen objects that identify a single category of patient safety event. The patient safety category may correspond to one of a predefined set of two or more patient safety categories. Additionally, patient safety categories may, themselves, be defined by two or more parameters. For example, in an embodiment that supports distribution of patient safety data in accordance with AHRQ Common Formats standards, a patient safety category may be defined by patient safety parameters, one of which identifies one of a predefined set of patient safety event types and the other of which identifies one of a predefined set of severity levels. Following a care giver's selection of a patient safety event type and severity level appropriate for the patient safety event being documented, at least one embodiment of the patient safety application on mobile device 60 provides a remote input to patient safety system 20, which initiates the creation within patient safety database 22 of a patient safety data record corresponding to the applicable patient safety event.

The patient safety data record created by patient safety database 22 may comprise a form record that includes a predetermined set of fields corresponding to one or more database tables consistent with a schema appropriate to support necessary or desirable internal administrative functions including, without limitation, the creation of periodic and user generated reports, listings of database records within the database, statistical and other types of analyses of the database records or subsets of the database records that comply with specify a bowl criteria, and other suitable database management functions. In addition, the schema defined for patient safety database 22 may include fields or otherwise store values for parameters specified by a standard, protocol, or practice of a third-party. Referring again to the AHRQ Common Formats example, patient safety database 22 may employ a schema that includes fields defined by the AHRQ CF.

Consistent with the structure of the patient safety database, patient safety system 20 may include a module or other resource to access records in patient safety database 22 and ready them for delivery to an external agency or other entity. In the case of AHRQ CF reporting, patient safety system 20 may include functionality for, or access to externally provided functionality for an institutional patient safety evaluation system (iPSES) as defined under the PSQIA, to transmit PSWP data a third-party entity 80, such as a PSO, which may include its own database management system 81 coupled to database storage 82.

FIG. 1 illustrates patient safety network 24 including two or more local wireless networks 50, of which two are illustrated (50-1 and 50-1). Each local wireless network 50 illustrated in FIG. 1 is associated with a corresponding healthcare facility 51. In other embodiments, a facility 51 may employ two or more local wireless networks 50 consistent with the physical size of the facility and the data transfer requirements of the facility. Mobile devices 60 may connect to patient safety network 24 by establishing a wireless connection with a local wireless network 50. Each local wireless network 50 illustrated in FIG. 1 represents a wireless communication interface maintained by a corresponding wireless access point 52. Each wireless access point 52 is illustrated coupled to a patient safety access network 12-5 of patient safety system 20.

In some embodiments, a local wireless network 50 may represent an IEEE 802.11-compliant (Wi-Fi) network that either broadcasts or suppresses a Wi-Fi network name (SSID), and establishes connections either with or without an SSID password. In these embodiments, a care giver 61 may be required to provide input in the form of a Wi-Fi SSID, a Wi-Fi network password, or other suitable input, to establish a connection 54 to Wi-Fi network 50. In other embodiments, a wireless access point 52 may suppress SSID broadcasting and employ an algorithm or other mechanism that changes the SSID and/or password from time to time. In these embodiments, the patient safety application of mobile device 60 may be configured to determine the current SSID and/or password and log into or otherwise establish a connection to local wireless network 54 without participation and perhaps without knowledge of the care giver 61 associated with the mobile device so that the local wireless network 54 may be inaccessible to mobile devices not equipped with the patient safety application.

FIG. 1 further illustrates examples of external computational and informational resources that patient safety system 20 may access or invoke during the process of creating patient safety database records in response to remote inputs from mobile devices 60. The external resources and informational sources of FIG. 1 includes external databases 73-1 and 73-2, external processing resource 72, and external storage resource 71. External databases may include, as examples, patient identification databases that maintain patient information for patients associated with patient safety platform 10 or any of the health care facilities 51 supported by patient safety platform 10, medical record databases providing electronic health records (EHRs) of patients associated with patient safety platform 10 or any of the health care facilities 51 supported by patient safety platform 10, prescription drug databases providing information regarding dosages, alternatives, indications, and other information pertaining a particular medication, and medical device / medical equipment databases providing operational and maintenance information regarding medical devices providing services. In the context of FIG. 1, a reference to a resource as an external resource conveys that the resource is external to the patient safety system 20. A particular resources that is referred to as external may be a part of the patient safety platform 10 or part of the a health care facility 51 supported by the patient safety platform 10.

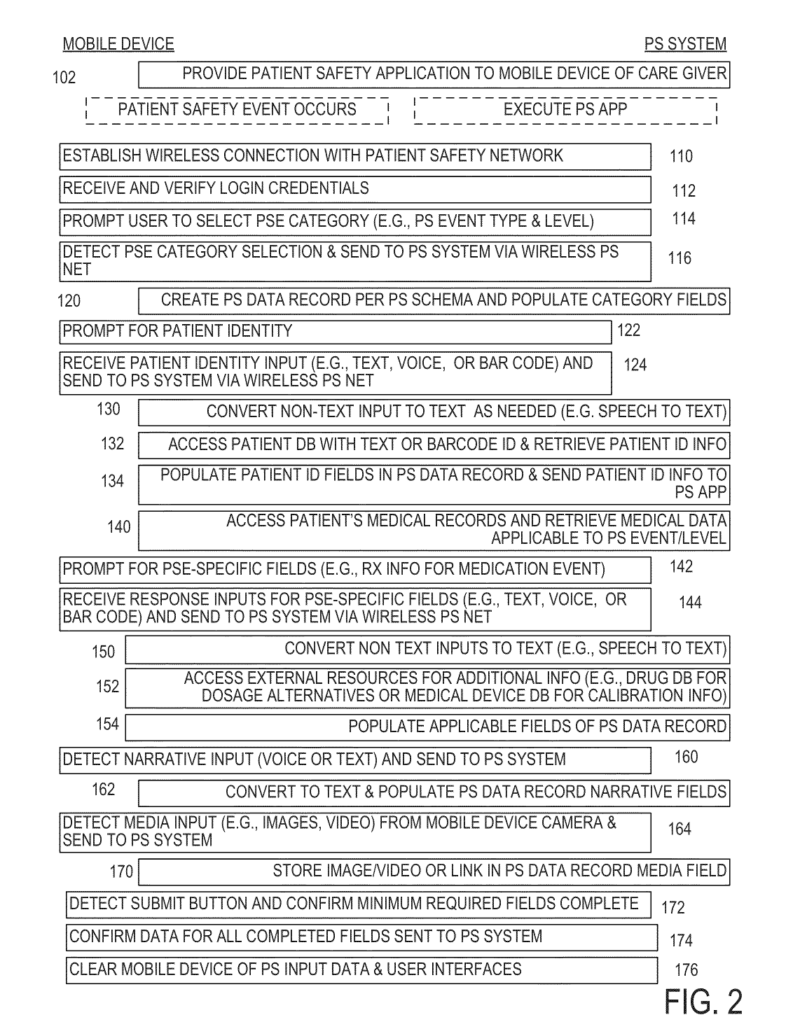

FIG. 2 illustrates selected elements of exemplary interaction between mobile device 60 (FIG. 1) and patient safety system 20 (FIG. 1) to create a patient safety data record for inclusion in patient safety database 22 (FIG. 1) based upon inputs provided remotely from mobile device 60. The method 100 illustrated in FIG. 2 conveys operations performed by mobile device 60 using text boxes aligned to the left and operations performed by patient safety system 20 using text boxes aligned to the right. Although FIG. 2 illustrates the various operations arranged in a particular sequence, the illustrated sequence reflects implementation details that may not be required of every embodiment such that the operation sequence is not mandatory unless a particular sequences is expressly described as necessary or the necessity of the ordering is inherent or unambiguous from the context. For the sake of clarity, the description of operations 100 below omits reference numerals with respect to the elements performing the illustrated operations, i.e., the mobile device 60 of FIG. 1, the patient safety application

The operations 100 illustrated in FIG. 2 include the patient safety system providing (operation 102) the patient safety application to the mobile device. The patient safety system may provide the patient safety application either directly to the mobile device or via a third-party portal or file server. For example, the patient safety application may be made available via application websites of various mobile device suppliers. The patient safety application enables mobile devices to remotely signal the patient safety system to initiate the creation of a patient safety database record. As described below, embodiments of the patient safety application support various non-textual input types to simplify and quicken the mobile device interaction required of the mobile device user to transmit sufficient information regarding a patient safety event to trigger the creation of a patient safety database record.

FIG. 2 includes dotted line elements representing the occurrence of a patient safety event and the mobile device user opening or otherwise executing the patient safety application, which may occurring in either order, in dotted lines to indicate that the timing of these events may vary. For example, a patient safety event may occur before a patient safety application is downloaded to a mobile device. Similarly, the mobile device user may execute and initiate the patient safety application, once downloaded, before or after a patient safety event occurs.

FIG. 2 illustrates the mobile device establishing a connection with the patient safety network at operation 110. The mobile device may establish a connection with the patient safety safety network by establishing a connection with a local wireless network maintained by a wireless access point. For embodiments in which the wireless access point is a Wi-Fi access point, the mobile device user may connect the mobile device to the local wireless network in the conventional manner, whether with or without a network password, via standard mobile device configuration settings or operating system utilities. In other embodiments, the local wireless network may be hidden or otherwise made inaccessible to mobile devices other than mobile devices executing a patient safety application. In these embodiments, broadcasting of the local wireless SSID may be suppressed, i.e., not broadcasted publicly. Alternatively or additionally, the local wireless network may incorporate a password or other means for limiting access.

In some embodiments, the process of connecting the mobile device to the local wireless network may be integrated into the patient safety application so that the mobile device user either does not have to perform any functions or provide any input to connect to the network. In still other embodiments, the patient safety network may be implemented such that the mobile device user is prevented from connecting to the network and it is the responsibility of the patient safety application to establish the connection. For example, the SSID of the local wireless network may vary according to a secure algorithm executed by the applicable wireless access point. In embodiments of this type, the patient safety application may include a similar or complementary algorithm to determine the current name of the network and/or the current password. In some of these embodiments, an SSID or network password may be generated from an algorithm that requires the mobile device user to input a seed or key wherein, after verifying the seed or key from the mobile device, the mobile device may be able to determine the current value of the SSID and/or password.

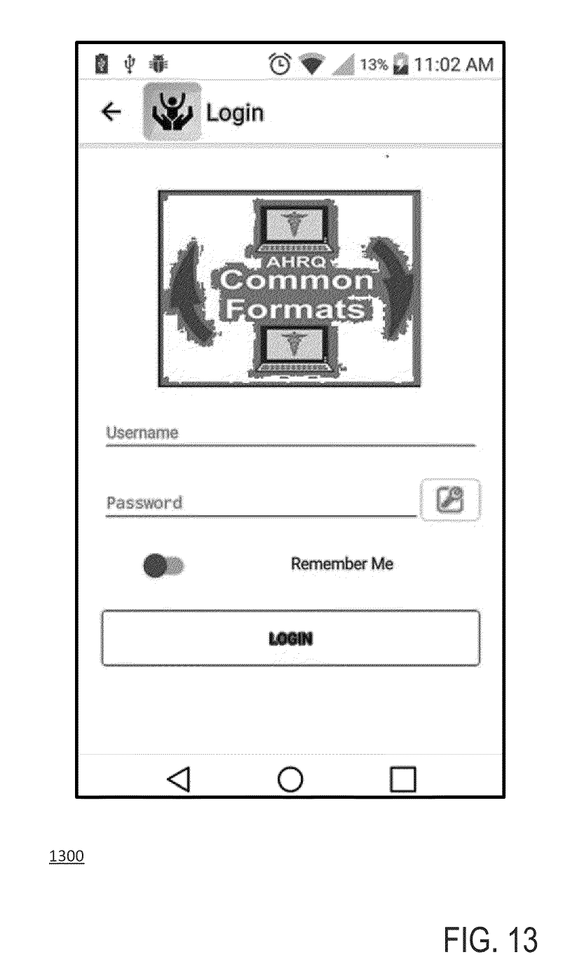

After a patient safety event occurs, a mobile device user may document the patient safety event by first opening or executing the patient safety application. In at least one embodiment, the patient safety application present the mobile device user with a user interface for providing login credentials. See, e.g., FIG. 13 login user interface 1300. The patient safety application, upon determining that the mobile device user has entered login credentials including, in at least some embodiments, a user name and password, receives and verifies (operation 112) the login credentials. FIG. 2 illustrates operations occurring assuming the login credentials provided by the mobile device user are verified. The patient safety application includes code or procedures (not depicted in FIG. 2) for preventing access when the login credentials cannot be verified.

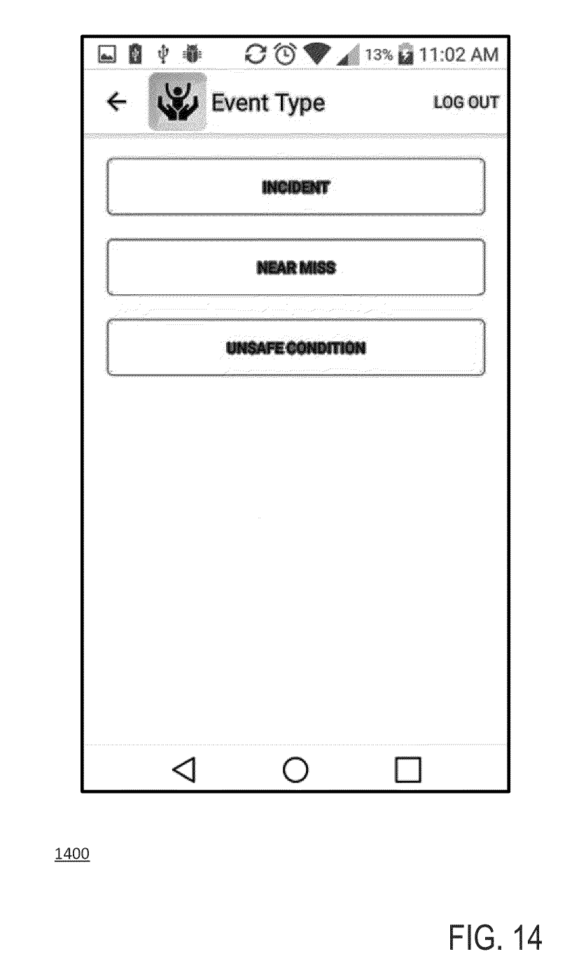

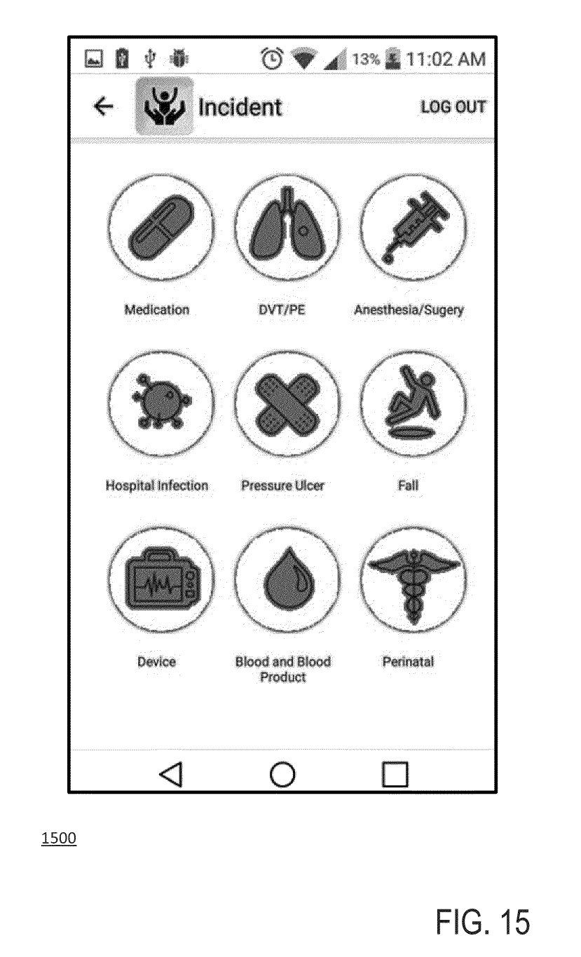

In at least one embodiment, the patient safety application presents a set or sequence of user interfaces and/or selection fields to the mobile device user to obtain information documenting a patient safety event. The operations 100 illustrated in FIG. 2 begin by prompting (operation 114) the mobile device user to select a patient safety event category from a sequence of one or more users interfaces. Other embodiments may begin by prompting the user for information, such as the identity of the patient, other than the patient safety event category. The patient safety event category is useful as the first piece of information provided to the patient safety application because the patient safety event category may determine, at least in part, the set or sequence of information fields that the patient safety application will prompt the user to provide. In embodiments emphasizing or encompassing patient safety data that may be or must be reported to a PSO as PSWP, the selection of a patient safety event category in operation 114 may include prompting a user to provide an indicator of a patient safety event type, see, e.g., FIG. 15 event type user interface 1500 and a patient safety event severity level, (e.g., severity level user interface 1400, FIG. 14) sometimes referred to herein simply as the patient safety event level.

Upon detecting mobile device user entry of patient safety event category selected by the mobile device user, the patient safety application illustrated in FIG. 2 sends (operation 116) data indicating the selected patient safety event category to the patient safety system over the patient safety network.

FIG. 2 illustrates the patient safety system, upon receiving the remote input indicating the patient safety event type and level, creating (operation 120) a patient safety data record compliant with a patient safety schema or database. The patient safety system, after creating the patient safety data record pertaining to the patient safety event being reported by the mobile device user, may automatically populate patient safety event fields of the newly-created patient safety data record pertaining to the category of patient safety event being reported. In embodiments encompassing PSWP provided to PSOs, as one non-limiting example, the patient safety data record may include a field for patient safety event type and a field for patient safety event level. In these embodiments, the patient safety system, after creating a patient safety data record in response to receiving a remote input indicating the patient safety event category, may automatically populate any fields in the newly generated data record pertaining to patient safety event type.

The operations 114 and 116, in conjunction with user interface of FIG. 14, illustrate the patient safety application's ability to initiate the creation, by the patient safety system, of a data record corresponding to a patient safety event being reported, based on nothing more than two menu selection inputs from the patient safety application. In other words, FIG. 2 illustrates an embodiment in which the mobile device user, after logging into the patient safety application, can remotely create a patient safety database record with two touches of the touch screen display of the mobile device. The ease with which a new data record is created beneficially facilitates timely and consistent documentation of patient safety events. In contrast, an application or system requiring typed text input defining a patient safety event category may potentially serve as a barrier to consistent and timely reporting.

After determining the patient safety event category and creating a new patient safety data record in the patient safety database, the patient safety application will provide the user with a set or sequence of prompts for various pieces of information that are consistent with the applicable patient safety event category. Upon receiving inputs to at least some of the various fields, the patient safety application may send data indicative of information in a given field to the patient safety system via the patient safety network. The sequence in which the information is received may vary from implementation to implementation and the mobile safety application may be configured to send every new piece of information upon receipt or to send only after the mobile device user indicates completion of a sequence.

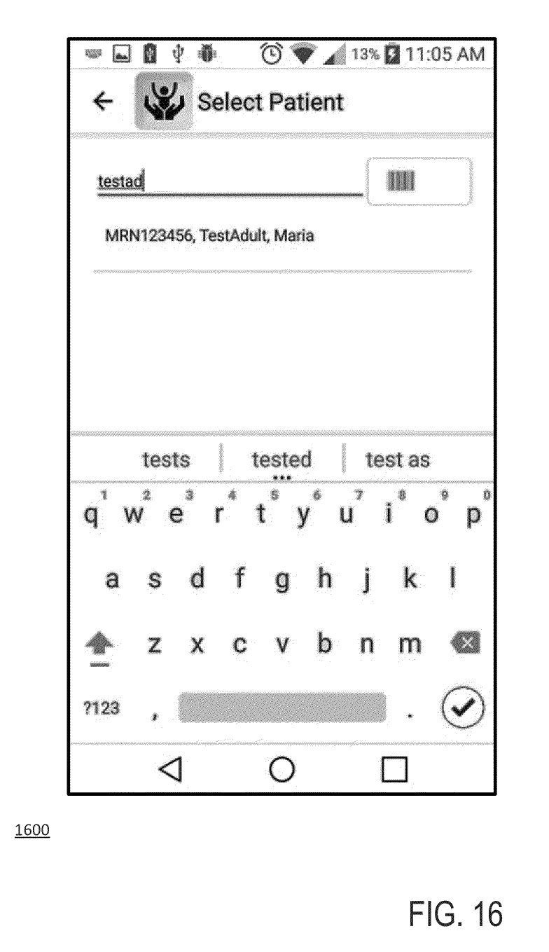

The operations 100 illustrated in FIG. 2 include the patient safety application prompting (operation 122) the mobile device user for information identifying the patient. In at least one embodiment illustrated by the patient safety application user interface 1600 of FIG. 16, the patient safety application may prompt the mobile device user for the patient identity with a prompt that supports input from a barcode reader, illustrated in FIG. 16 as element 1602. In this embodiment, the mobile device user may touch the barcode element 1602 on the user interface 1600, at which point the patient safety application may invoke a barcode reader module, either integrated within the patient safety application or accessible to the patient safety application as an external application, to access barcode scanning functionality of the mobile device to and fill the patient identity field 1602 of user interface 1600.

The mobile device user may, if no barcode is being worn by the patient, input the patient identity using conventional keyboard data entry provided by the mobile device. The patient safety application may further support voice input and may include a microphone icon within user interface 1600 to provide speech input, although some embodiments of the patient safety application, including the embodiment represented by user interface 1600 of FIG. 16, may elect not to offer voice input as an option for inputting patient identity in recognition of the fact that names may be easily misinterpreted or misspelled by a speech to text processor.

The operations 100 illustrated in FIG. 2 include the patient safety application receiving (operation 124) the patient identity input received by the patient safety application and sending the information to the patient safety system via the patient safety network. As described previously, the information sent to patient safety system via the patient safety network may be in the form of text, voice, or an indicator of the output of a barcode scanner, which may be in the form of text, a numerical value, or encoded binary information indicating either a text, a number, or a combination thereof.

The operations 100 illustrated in FIG. 2 further include a patient safety system converting (operation 130) any non-text input to text or another format appropriate for the patient safety data record into which the information will be stored. The patient safety system may then access (operation 132) a database, such as a master patient indexer, maintaining patient identification information. The patient safety system may provide the patient information with a text indicating the patient's name or bar code information identifying the patient by one or more numerical values. The patient safety system may retrieve values from the patient information database that may be required by or optional with respect to the patient safety database. The patient safety system may then automatically populate (operation 134) patient identification fields in the newly-created patient safety data record. The patient safety system may also send all or some of the patient information retrieved from the patient identification database and send the information to the mobile device. The patient safety application may access any information provided from the patient safety system and employ the information to supplement one or more of the fields of one or more user interfaces presented to the mobile device user by the patient safety application. For example, if a mobile device user scans a bar code to convey patient identification information, the patient safety system receiving the bar code information may, after accessing the master patient indexer to obtain additional patient information, provide the name of the patient back to the patient safety application, which may use the information to fill in the patient identify field and thereby convey the name of the patient to the mobile device user.

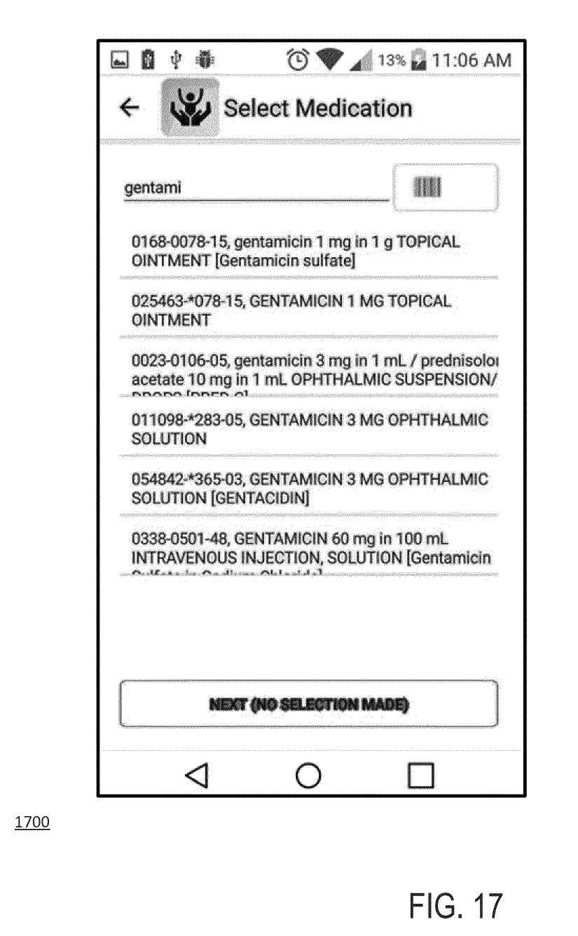

FIG. 2 illustrates patient safety application prompting (operation 142) the mobile device user for patient safety event-specific fields such as, for example, a field requesting medication information for a patient safety event pertaining to medication. See, e.g., FIG. 17 user interface 1700. The patient safety application receives (operation 144) response inputs for one or more patient safety event-specific fields. Each of the inputs, like the patient identification input, may be in one of various formats supported by the patient application including, text, voice, barcode, or electronic information of another type including as an example a radio frequency identifier. In at least one embodiment, the patient safety application forwards the input provided in the format in which it was received and any conversion of the input occurs within the patient safety system or by an external resource accessed by the patient safety system. A conversion (operation 150) of any non-text data to text also encompasses conversion to a format other than text when a format other than text is specified by the format of the patient safety data record.

The operations 100 of FIG. 2 include operation 152, in which the patient safety system accesses an external resource for additional information pertaining to a particular patient safety data record field, and operation 154 in which any information that is retrieved from an external source and that corresponds to a field of the patient safety data record, may is automatically populated in the appropriate patient safety data record field. A non-limiting example illustrating these features includes the patient safety system accessing an external database of prescription medication information upon receiving an identifier of a particular medication associated with the patient safety event being documented. The external database provides the patient safety system with additional records or information about the applicable medication. In the example of a prescription medication, for example, an external prescription medication database may return to the patient safety system a list of similar or alternative medications as well as a list of the dose and frequency of approve protocols for administering the drug. In some embodiments, this additional information may or may not be used directly by the patient safety system, but the information may be sent back to the patient safety application to enable the patient safety system to provide a drop-down menu so that the mobile device user may simply select the appropriate choice for a related field. In the example of prescription medication, the patient safety system may provide a list of dosages and frequencies typically prescribed and the mobile device user may select among these to indicate the dose and frequency the patient was intended to receive.

Operations 100 of FIG. 2 to further include operations enabling mobile device to detect (operation 160) narrative input, whether by voice or text, and send the input to the patient safety system. The patient safety application may include optional or mandatory fields for providing narrative input and in any of these fields, at least one embodiment of the patient safety application may indicate a microphone or another element to enable the mobile device user to speak the narrative into the form using the microphone of the mobile device. Again, at least one embodiment of the patient safety application sends input to the patient safety system in the form that it was received any conversion of the input received by the patient safety system is done by the patient safety system or an external resource accessed by the patient safety system. Thus, FIG. 2 illustrates patient safety system converting (operation 162) text from voice and populating any patient safety data record narrative fields.

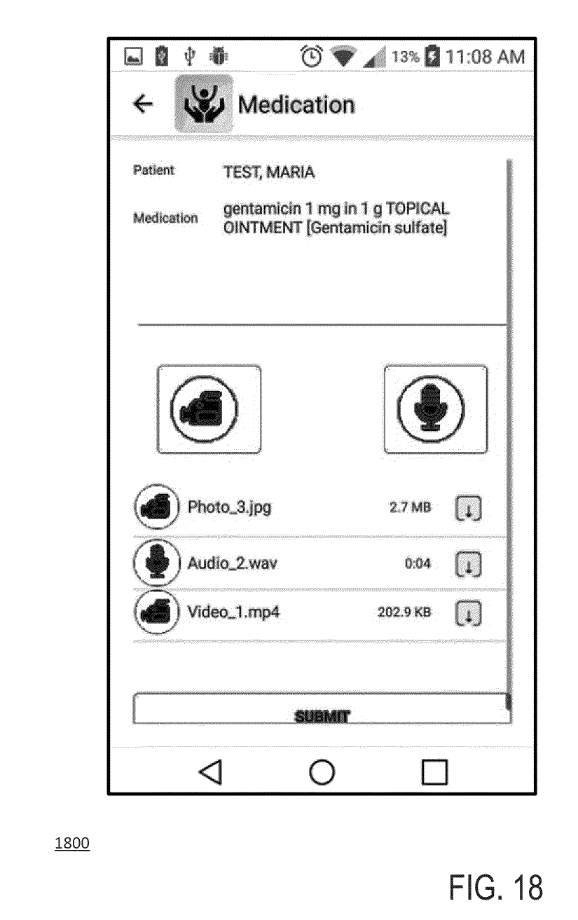

FIG. 2 illustrates the patient safety application supporting media input in the form of still or motion images, video, etc., that include video and voice in operation 164. In this embodiment, the mobile device includes a camera or other image capture device capable of generating a still image or a video or multimedia file. This multimedia information may be incorporated into the inputs provided to the patient safety system by the patient safety application. For example, an image of the scene of a patient fall may be sent to the patient safety system as an input that is stored (operation 170) within the applicable patient safety data record, either directly if supported by the format of the patient safety Decker data record, or as a reference to a file containing the image. The exemplary user interface 1800 in FIG. 18 illustrates the patient safety application ready to submit information pertaining to the applicable patient safety event with information that includes a patient identifier, a medication identifier, an image or photo in jpg format, an audio file in a way format, and a video file in an mp4 format.

The operations 100 illustrated in FIG. 2 include the patient safety application detecting (operation 172) the mobile device user's selection of a submit button or another feature indicating that the mobile device user has provided all of the patient safety event information that he or she can provide. The embodiment of operations 100 illustrated in FIG. 2 include operation 174, in which the patient safety application confirms that all required fields have been completed. This embodiment envisions an implementation in which the patient safety application contemplates fully completed patient safety event documentation when the patient safety event is created and reported. Other embodiments may, upon determining that not all required fields have been completed, provide the mobile device user with the option of either completing the required fields or completing the required fields at a later point in time. In the event that the mobile device user elects to complete the information at a later time, the patient safety application may send all of the information it has to the patient safety system so that the patient safety application can then remove all information pertaining to the patient safety event from the mobile device. The mobile device user may be able to retrieve the information by identifying the patient safety data record that was generated or by providing information that might be used to locate the patient safety data record. For example, the mobile device user may be able to retrieve the previously created data record by identifying a patient and the type of event and perhaps the date.

The operations 100 of FIG. to include, upon a confirmation that all required data for a given patient safety event category has been completed by sending (operation 174) to the patient safety system any information that has not been previously sent and Operations 100 may further include operations 176 in which, upon confirmation that all data has been sent to the patient safety system, by clearing the mobile device of any patient safety input data and restoring the patient safety application to its initial condition in which, on subsequent execution, the patient safety application will prompt the mobile device user for a patient safety event category and proceed as described above. In these embodiments, the patient safety application beneficially ensures that any information provided to the mobile device during the process of creating the patient safety data record is removed from the mobile device.

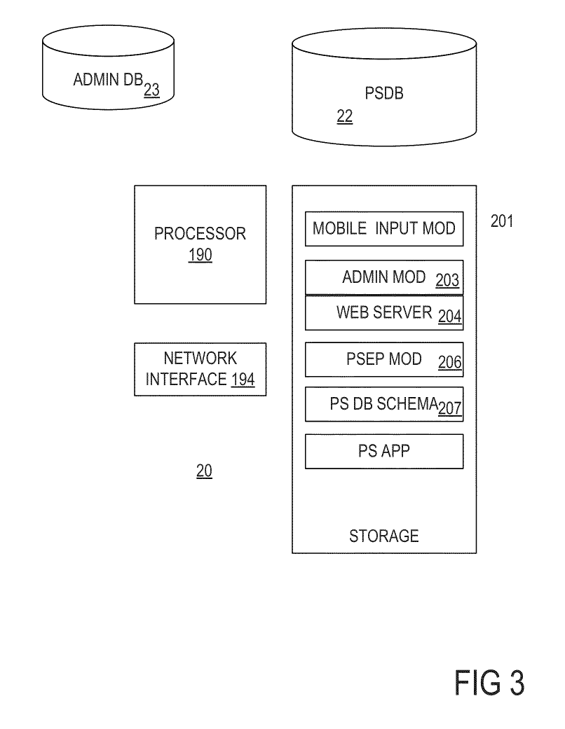

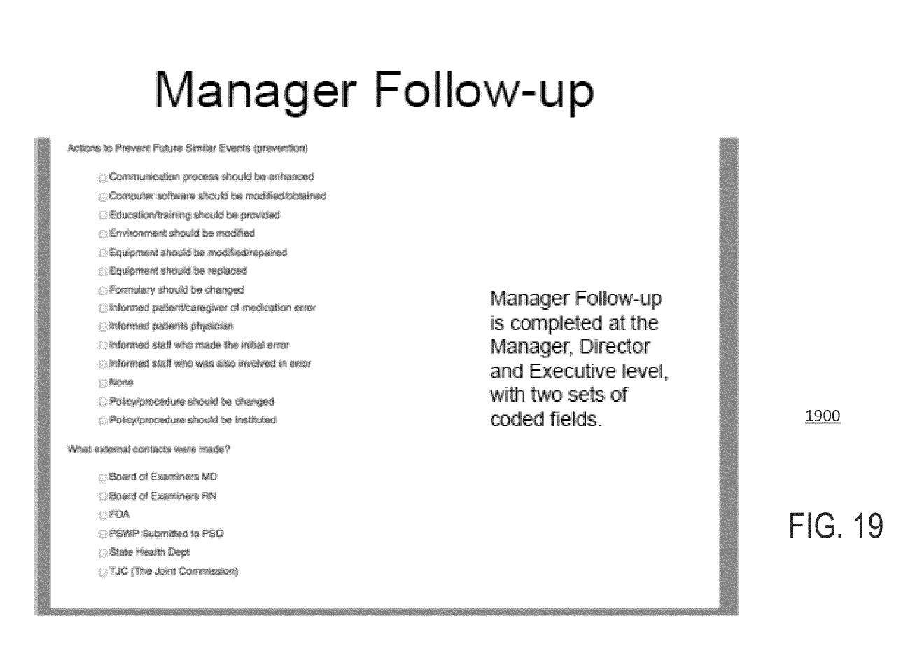

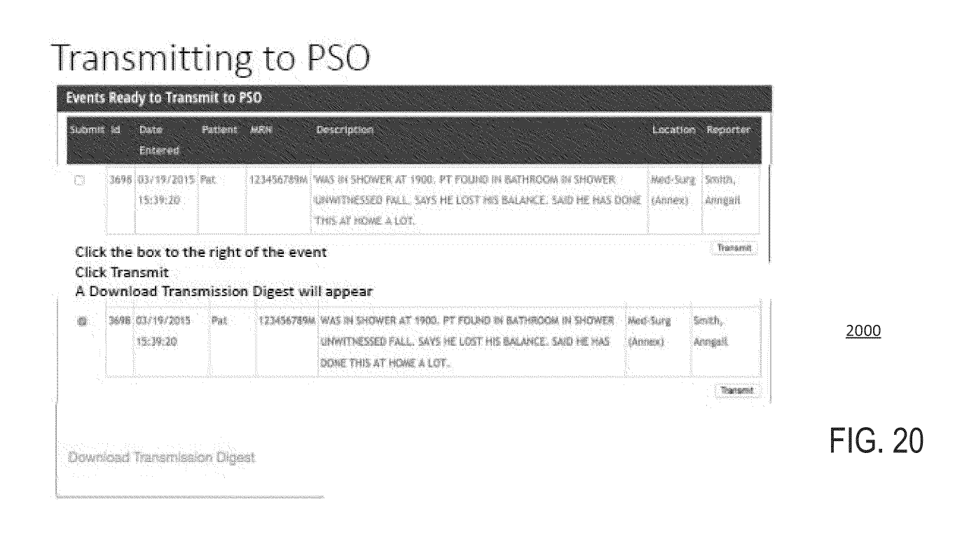

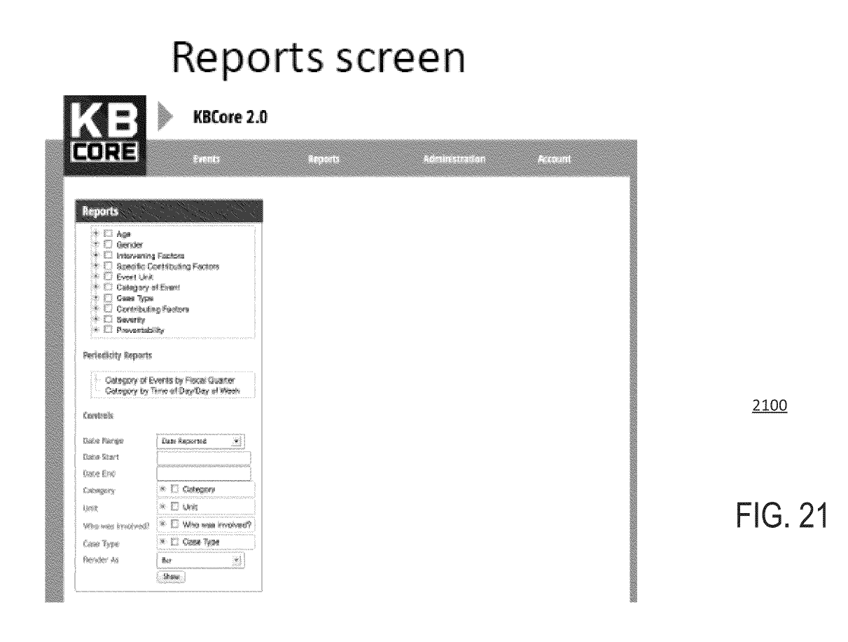

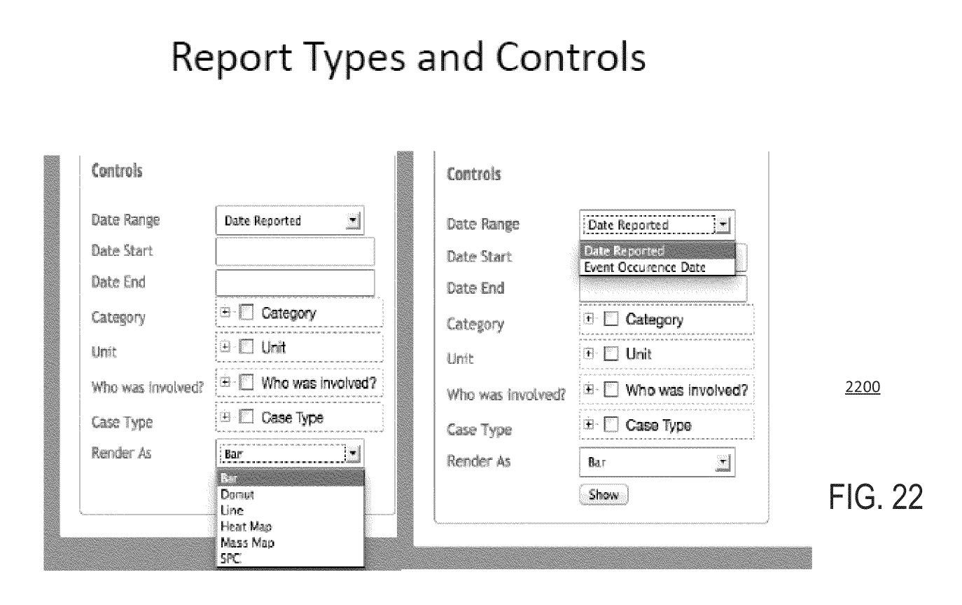

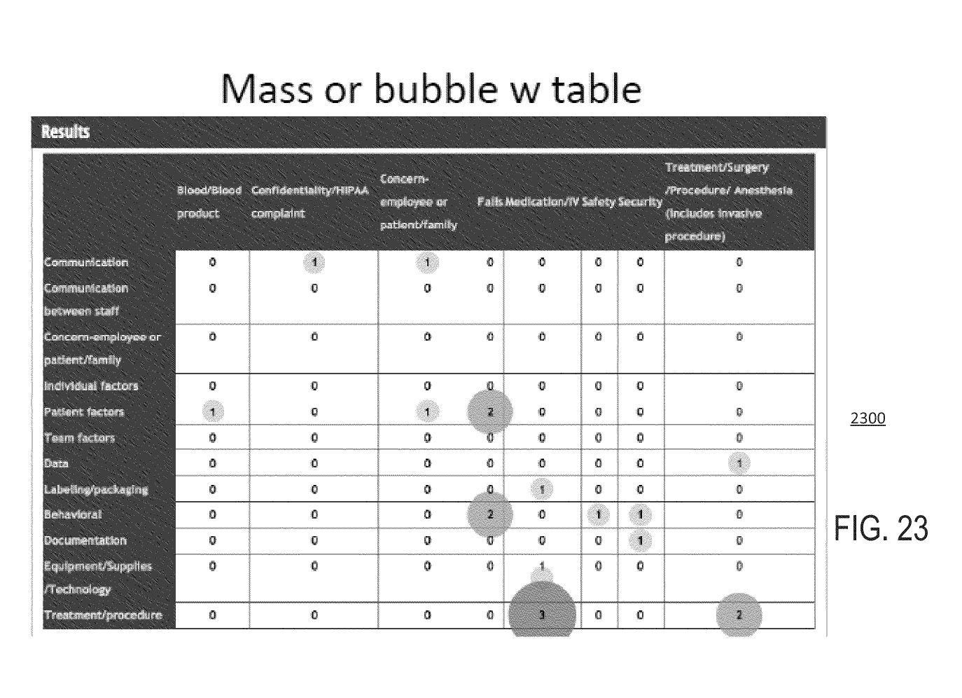

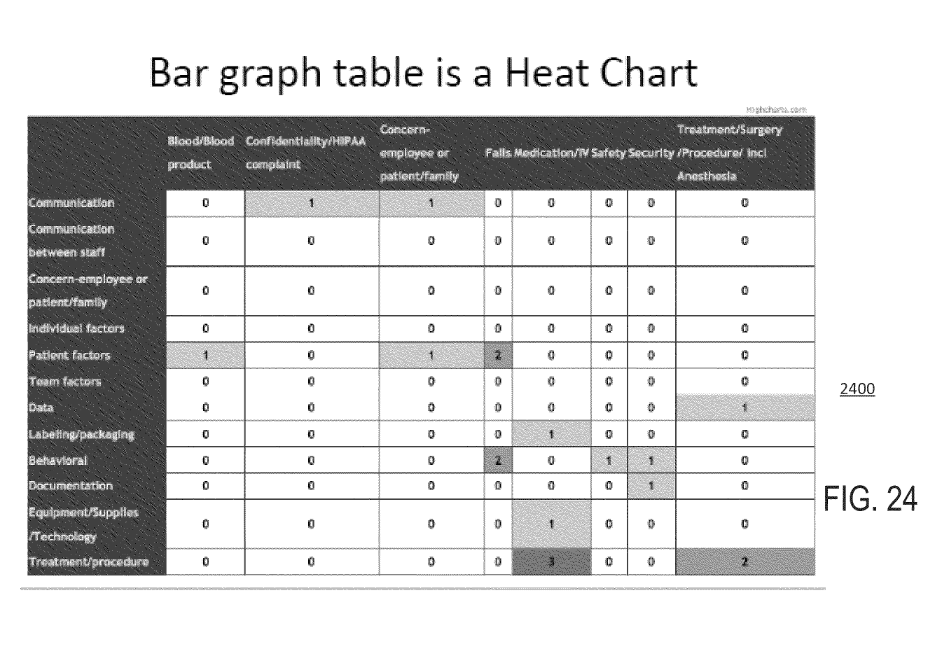

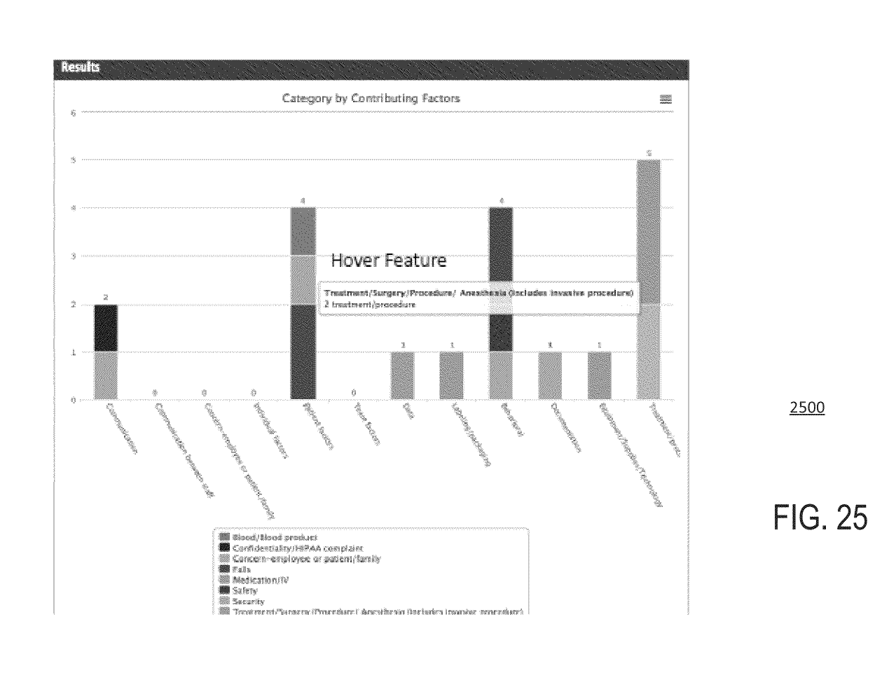

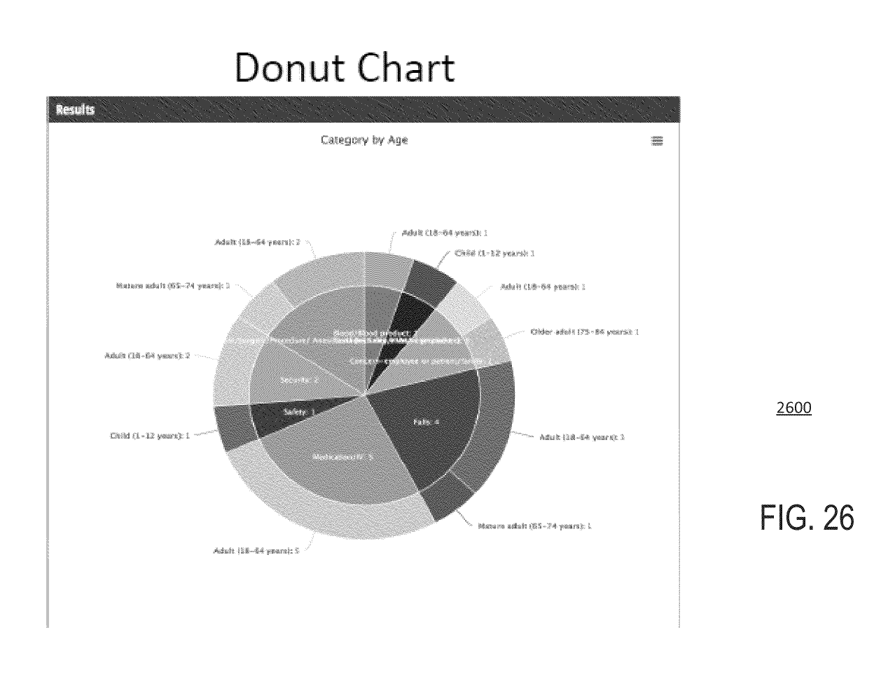

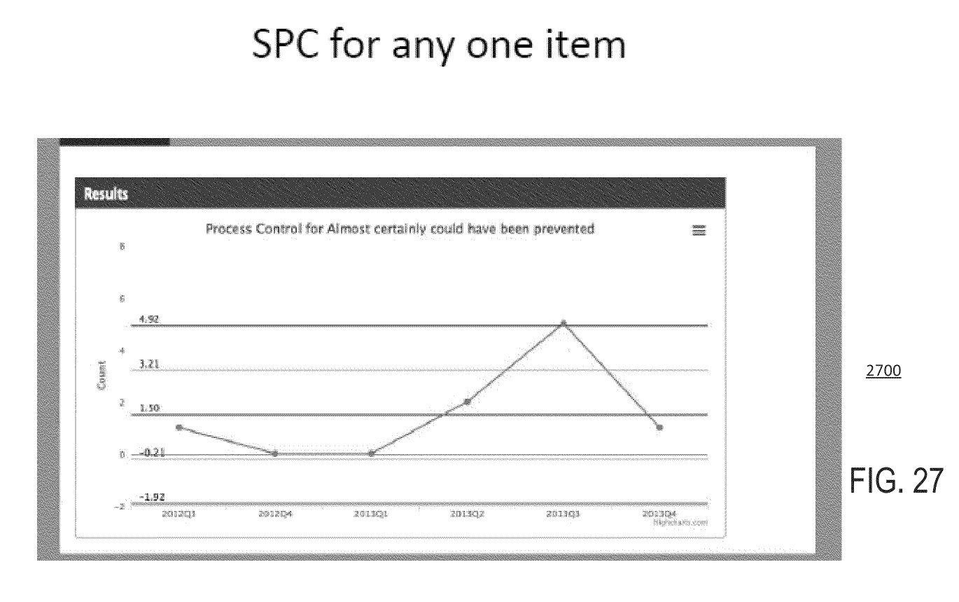

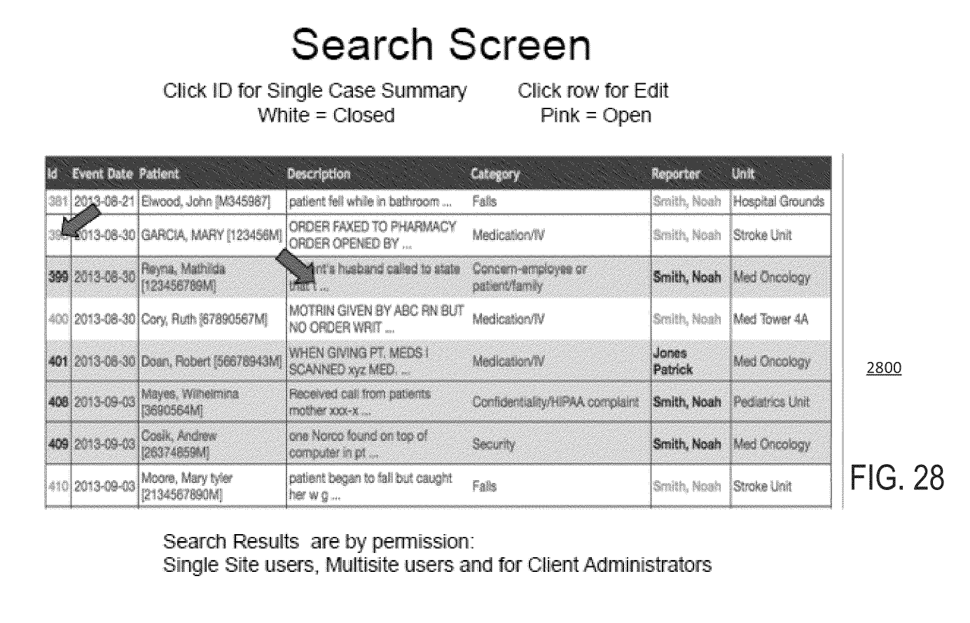

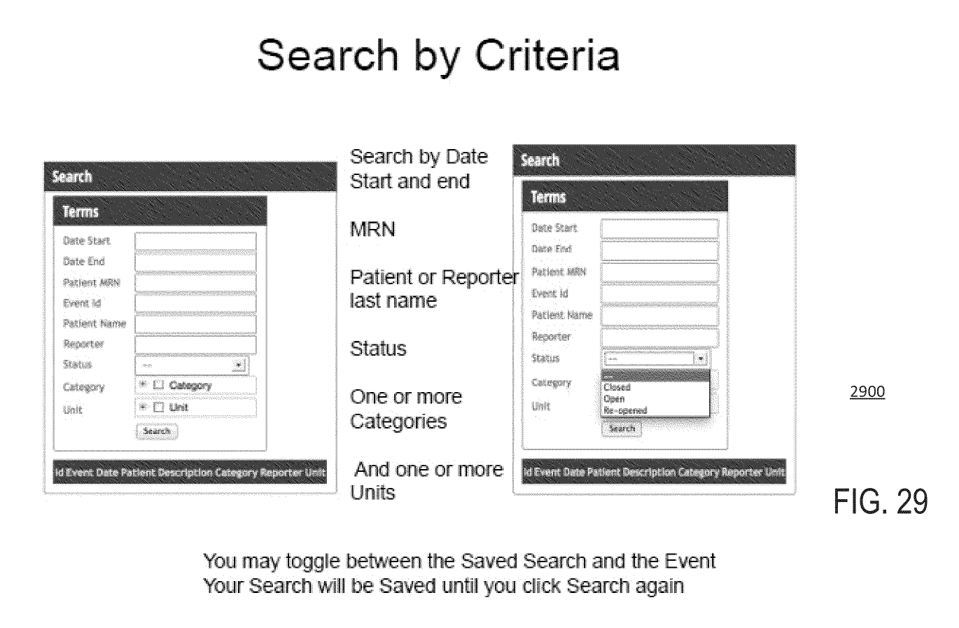

FIG. 3 illustrates selected elements of patient safety system 20. The patient safety system 20 illustrated in FIG. 3 includes a general purpose microprocessor 190 and a memory or storage device 192 including processor executable program instructions that may be executed by a processor 190 to perform various functions. Patient safety system 20 is illustrated further including a network interface 194 that enables the processor 190 to communicate with external systems and networks. FIG. 3 illustrates selected programs stored within storage device 192. The program is illustrated in FIG. to include remote input module 201, and administrative module 203 that includes support for a Web server 204, and a patient safety evaluation module 206. The remote input module 201 is responsible for interacting with the mobile devices via the wireless safety network described previously. Remote input module 201 may encompass all or some of the operational steps illustrated in FIG. 2 associated with the patient safety system. The administrative module 203 may function as the interface for an administrative user to access the patient safety database locally or from a web portal The storage device 192 of FIG. 3 includes patient safety database schema 207 representing a definition of the database maintained by the patient safety system. The database schema 207 may define the various fields of information necessary for compliance with one or more reporting standards. Exemplary user interfaces generated by at least one embodiment of the patient safety system are illustrated in FIG. 19 through FIG. 29, including user interfaces facilitating database searches, report generation, record listings, statistical analysis, and trending, including graphical summaries of selected data base records.

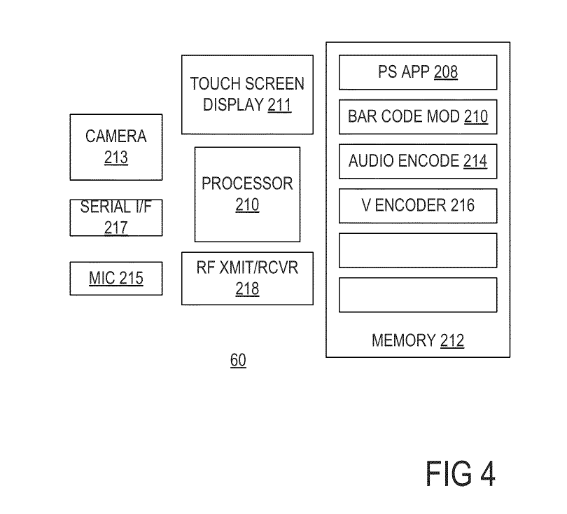

FIG. 4 illustrates selected elements of a mobile device 60. The mobile device 60 illustrated in FIG. 2 includes a processor 210 and a memory device 212 that includes software programs executable by processor 210. The mobile device 60 of FIG. 4 includes, in addition to processor 210, a touch screen display 211, a camera 213, a serial interface 217, and a microphone 215. The radio frequency transmitter receiver 218 is suitable for providing a wireless connection to a wireless network. RF transmitter/receiver 218 may support various wireless communication protocols including, as examples, Wi-Fi, Bluetooth, and other local area wireless protocols as well as one or more types of cellular networks including 3G, 4G, and 5G wireless protocols. Camera 213 provides an image capture device that may be used in conjunction with an video encoder 214 to generate a still or motion video file that can be delivered to an external source. The microphone 215 illustrated in FIG. 4 is operable to convert speech to an electronic or audio file that may be generated in conjunction with audio encoder 214. The serial interface 217 may provide mobile device 60 with an interface for connecting to a wireline network or to a device via a wireline connection. The software programs illustrated in memory device 212 include a barcode scanner 210 that may be used in conjunction with a digital image captured by camera 213. The barcode scanner may convert a digital image of a barcode into an alphanumeric string or a binary encoded number or another similar format. The mobile device 60 illustrated in FIG. 4 is shown with a patient safety application 208 installed in memory 212 and executable by processor 210. The patient safety application 208 represents the mobile device software described with respect to FIG. 2 for interacting with the patient safety system 20 to provide the patient safety system with information regarding a patient safety event. Exemplary user interfaces of at least one embodiment of the patient safety application 208 are illustrated in FIG. 13-FIG. 18.

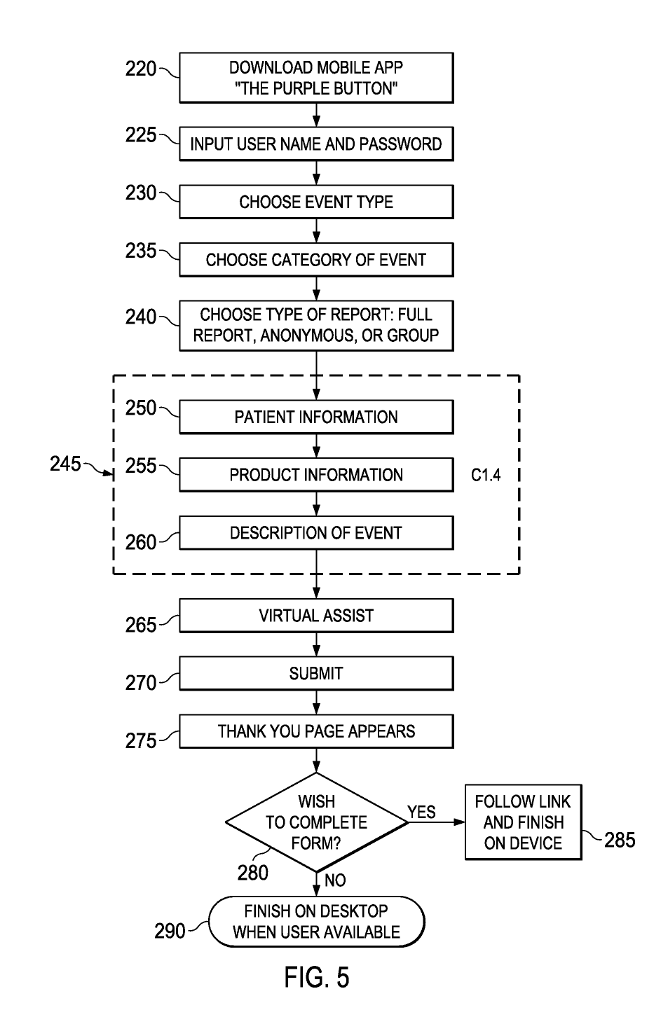

FIG. 5 through FIG. 12 illustrate embodiments of selected patient safety platform methods supported by patient safety platform 10. FIG. 5, for example, illustrates a method of using the patient safety application to collect and send patient safety data to a PSO. FIG. 5 illustrates downloading (220) of the patient safety application as an initial step in the depicted embodiment. When the patient safety application is opened, a user name and password may be required 225. Next, the mobile device user may choose (230) a patient safety event level, where there may be three types of patient safety events to choose from: incident, near miss, and unsafe condition. The mobile device user may then choose a patient safety event type selected from a group of event types that includes: Medication, Devices, Blood and Blood Product, Falls, Surgery and Anesthesia, DVT/PE, Healthcare Associated Infection, Pressure Ulcer, Perinatal.

The mobile device user may then choose (240) a type of report anonymity. As seen there may be three types of reports; Full Report, Anonymous, and Group. Patient information may be provided (250) if event involved a patient. Next, if category of event was either Devices, Blood and Blood Product, or Medication, Product Information 255 will be required. Next, a description of the event 260 allows for a narrative for the user to describe what happened during this event. During this step there is an option for Virtual Assistance 265, at the click of a button proper personnel will be connected in real time to user through video conferencing. Personnel should then have the ability to notify all needed departments to help user with event in real time. Once all information is entered, user will submit report 270. A ‘Thank You’ page 275 will appear with the event ID number and a web link. The user has a choice to complete the full report immediately 280. If user wishes to complete full report immediately they will follow the link 285. If not, user will close out application and utilize a desktop and finish the full report at a later time 290.

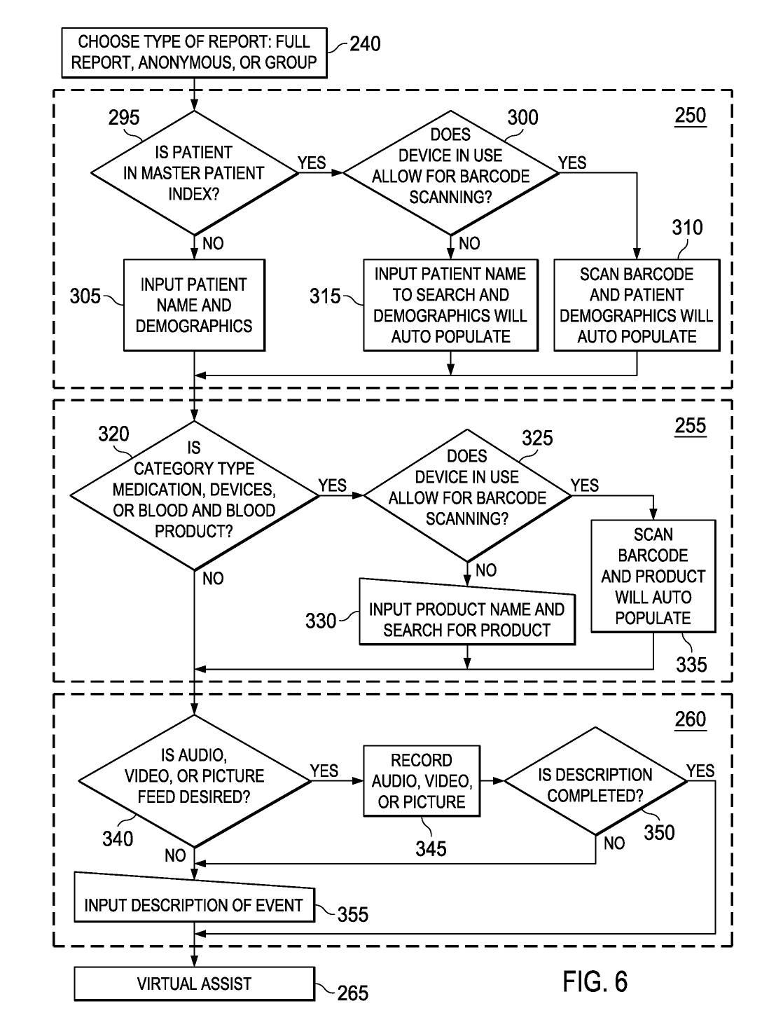

FIG. 6 shows where acceleration services are utilized within the patient safety application. Patient Information, Product Information and description of event are the three steps that describe Acceleration Services in detail. Once the type of report is chosen (Full Report, Anonymous or Group) as shown in step 240, user may input patient information. If event involves a patient, user may determine if patient is in the Master Patient Index (MPI) 295. If person involved in an event is not in the Master Patient Index, user may input all personnel information and demographics 305. If person is in the Master Patient Index, user has the option to utilize acceleration service, barcode scanning 300. If barcode scanning is available user may scan patient's barcode and patient demographics may auto populate 310. If user does not have the ability to scan, user may input patient name and utilize search function 315, as the patient safety application may be linked to the facility's Master Patient Index through an API. After patient information is entered, product information is required if event category is Medication, Devices, or Blood and Blood Product 320. If category is one of the three listed, product number may be required to be reported. In order to capture product number barcode scanning is an option 325. If device allows for barcode scanning, user may scan barcode and product information will auto populate 335. If user device does not have the ability to scan or the product does not have a barcode, user may input product name and search through database 330. If product is a Medication or Blood and Blood Product the patient safety application may be linked to the FDA database and allow for the user to search and select the correlated product. The next step may include narrating a description of the event. In step 260, the user deals with description of the event in audio or video feeds. This is a major technical advantage of the system as it captures specific time data relating to the event. Though both the feeds are optional one can store valuable information about the event through these feeds. In step 340, the user may determine if the audio, video or picture feed is desired for the recording of the event. Step 345 shows that the user may then record the audio, video or picture feeds when desired. User can also attach images such as an X-Ray, CAT scan or photo from a Gallery. If there is no feed desired as seen in step 355, user can input description by typing in a narrative. If there is any other type of detail to be added to the description of the event the user can input a narrative description as shown in step 355. Once all information is entered, user has the option to utilize Virtual Assist 265 to communicate to other personnel if assistance is needed. Virtual Assist connects the user and an authorized personnel in real-time through a video feed. Once the communication is complete, the authorized personnel may connect user with others for assistance or authorized personnel may direct others to user's location for further assistance.

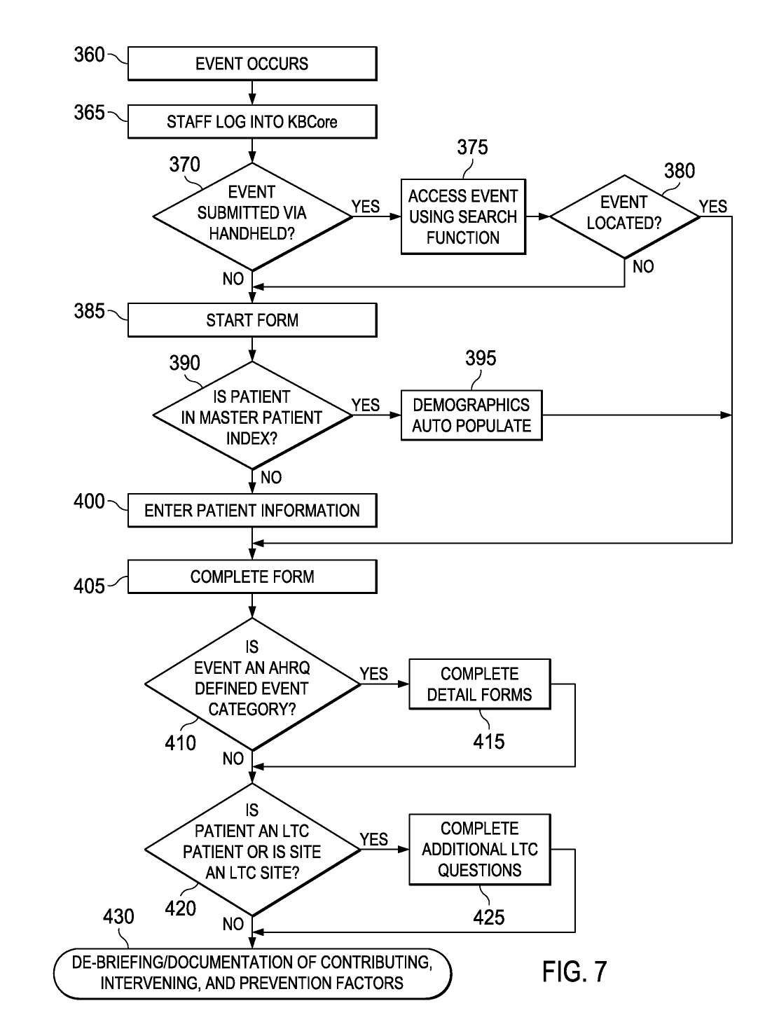

FIG. 7 illustrates how user may utilize a desktop application to create or complete an event. As an event occurs 360, an administrative user may log into the administrative module 203 of FIG. 2 365. User may determine if event occurred was submitted through a mobile device 370. If event was submitted through a mobile device, user may search for event 375. If event is located, user may access report and complete form 405. If event is not found or was not created using a mobile device, user may start form 385. User may determine if patient is in facility's Master Patient Index 390, if patient is in the Master Patient Index user may search through database and patient information may auto populate 395. If patient is not in the Master Patient Index then user may manually input all patient information required 400. Once the patient information is complete, user may complete form 405. User may then determine if event is an AHRQ defined event category 410. If yes, user may complete detail forms 415. If no, detail forms may not appear. If event is involving a patient of a Long Term Care (LTC) facility or the event occurred in a LTC facility 420, then user may complete additional LTC questions 425. If patient or location is not related to a LTC then user may continue on to the self-de-briefing/documentation of contributing, intervening, and prevention factors 430. In capturing the contributing, intervening, and prevention factors it supports analysis for review to improve quality.

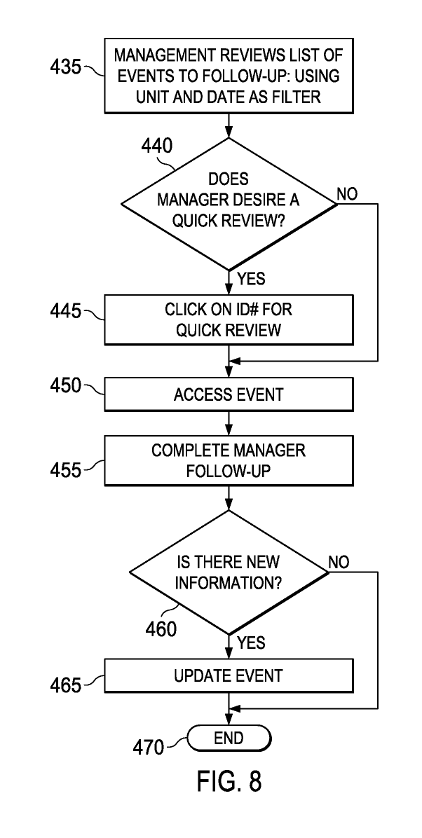

FIG. 8 shows how a manager may follow up on an event once a report is created. The manager may first look at the lists of events by using unit and date as a filter 435. The manager has an option to display a quick view of each event 440. If manager chooses to do so they may click on the event ID number and a quick summary of the event may display 445. If not, the manager may access event 450 by clicking on event. Manager may complete manager follow-up 455 portion at the bottom of the event report. After completion of the manager follow-up, the manager may have the option to update the event 460. If manager chooses, they may update the event 465 with additional information as the case is observed or investigated. If not, the manager follow-up is complete 470.

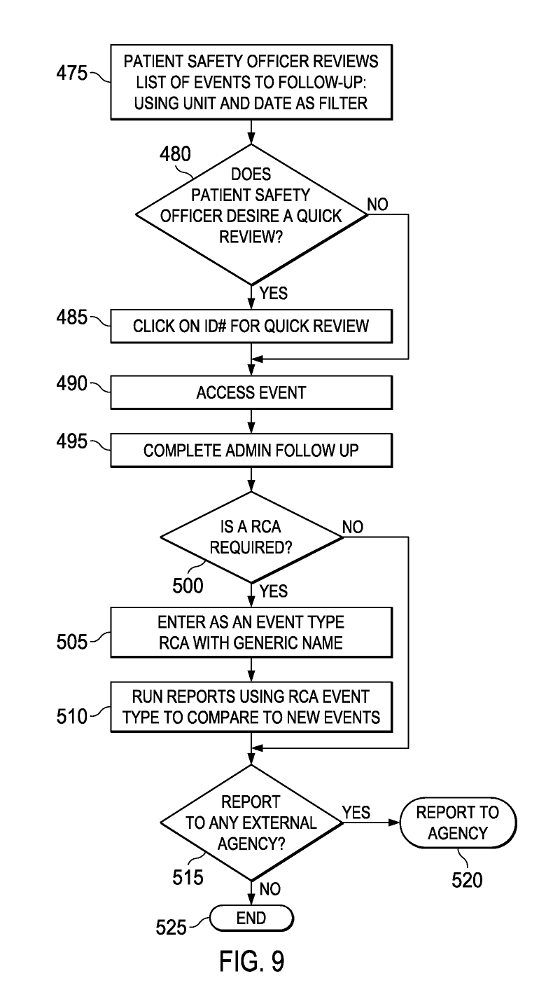

FIG. 9 illustrates the process of a Patient Safety Officer review on an event report. The Patient Safety Officer may review the list of events by using unit and date as filter 475. The Patient Safety Officer has an option to display a quick view of each event 480. If the manager chooses to do so they may click on the event ID number and a quick summary of event may display 485. If not, the manager may access event 490 by clicking on event. The Patient Safety Officer may complete admin follow-up 495. At this time the Patient Safety Officer may determine if a Root Cause Analysis (RCA) is required 500. If yes, the Patient Safety Officer may enter as an event type RCA with generic name 505 and run reports using RCA event type to compare to new events 510. After RCA report is created or if the Patient Safety Officer determined RCA is not required, the Patient Safety Officer may then determine if the event may be required to be reported to an external agency 515. If reporting to an external agency is required then a report is sent to appropriate agency 520. If reporting is not required then the review is complete 525.

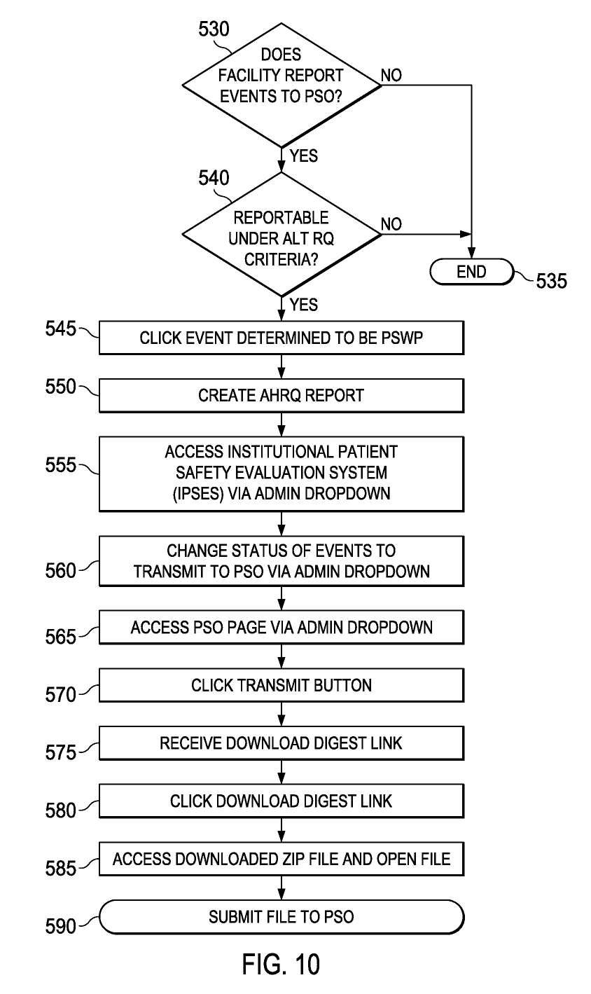

FIG. 10 illustrates how a facility may report an event to a PSO. First, it is determined if the facility reports to a PSO 530, if not the facility may not have the module or option 535 in the system. If the facility does report to a PSO, the Patient Safety Officer may determine if event is reportable under AHRQ criteria 540. If criteria is not met, that is a determinate that the event is not reported to the PSO 535. If criteria is met Patient Safety Officer may claim event determined to be PWSP 545 and create an AHRQ report 550. The Patient Safety Officer begins this process by accessing the iPSES 555. Once in the iPSES the event status is changed to “Transmit to PSO” by access through the Administration dropdown list 560. Through the Administration dropdown the Patient Safety Officer may access the PSO page 565. Select all events to be reported to PSO and click on Transmit button 570. After events are transmitted the Download Digest link may appear 575, click on Download Digest link 580, and a zip file may be download 585. The zip file may be accessed and submitted to the PSO 590.

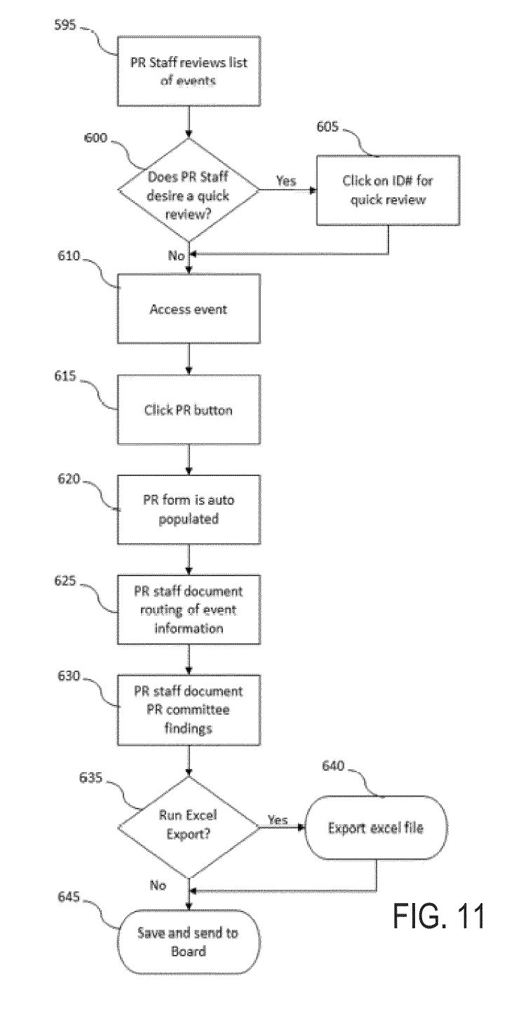

FIG. 11 illustrates the Peer Review (PR) process. The user can access PR staff review list of events 595. When PR staff first see the list of events the option for a quick review is available 600. If quick review is desired staff may click on event ID number for a summary of the form 605. If quick review is not desired, staff may access event 610. Then Click on PR button 615 and PR form is auto populated 620. PR staff documents routing of event information 625 and then documents PR committee findings 630. After all information is complete user has the option to run excel export 635. User may export excel file 640 or save file and send directly to board 645.

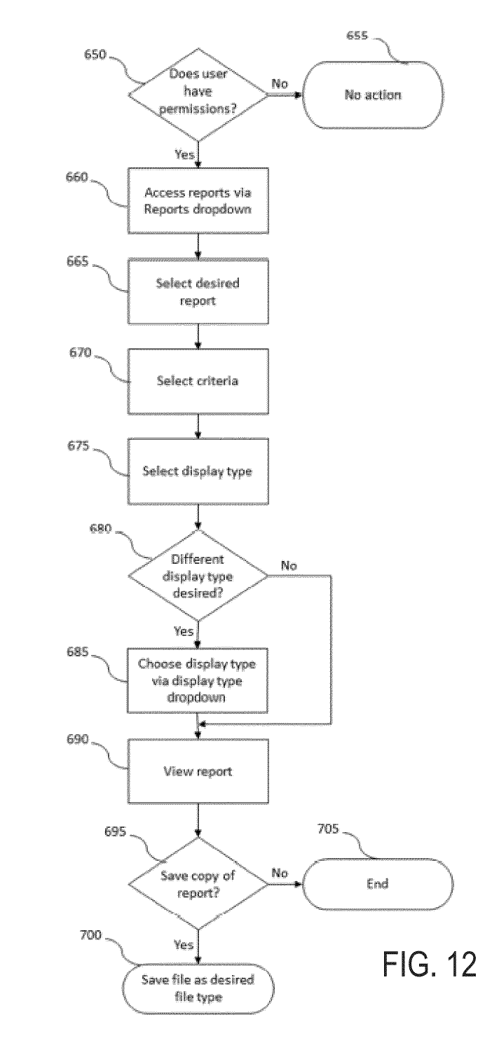

FIG. 12 (Running Reports) illustrates how a user may access a report and a graphical presentation of the report by setting criteria and filters. User permissions are determined 650, if user does not have permissions modules may not be present 655. If user has permissions module may be present and user may enter through Report dropdown 660. User may select desired report 665, select criteria 670, and display type 675. User has options of different display types 680 and if different display type is desired then user may change it through the display type dropdown 685. After all criteria and options are chosen report is viewed 690. Saving of the reports are allowed 696 and if desired then reports may be saved as different file types 700 such as; JPG, PNG, PDF, and SVG vector. If saving of the report is not desired then user may close out report 705.

To the maximum extent allowed by law, the scope of the present disclosure is to be determined by the broadest permissible interpretation of the following claims and their equivalents, and shall not be restricted or limited to the specific embodiments described in the foregoing detailed description.

What is claimed is:

1. A patient safety data method, comprising:
providing, by a patient safety system, a patient safety application to a mobile device of a mobile device user, wherein the patient safety system includes a processor and executable instructions that, upon execution, result in the processor performing operations comprising:
receiving remote inputs wirelessly transmitted by the mobile device over a patient safety network, wherein the remote inputs are indicative of information obtained by the patient safety application pertaining to a patient safety event;
responsive to receiving remote input indicating a patient safety event category, creating a patient safety data record, comprising a set of fields, corresponding to the patient safety event;
responsive to receiving a subsequent remote input wirelessly transmitted over the patient safety network by the mobile device, automatically populating at least some of the fields in the patient safety data record with values determined in accordance with the subsequent remote input;
storing the patient safety data record in a patient safety database;
responsive to a first user input indicative of a particular patient safety data record:
providing at least some of the fields in the particular patient safety record in a first output format suitable for inclusion within a patient safety data record user interface displayed to the user; and
responsive to a user input modifying an element of the user interface, modifying a corresponding field in the patient safety data record;
responsive to a second administrator input indicative of criteria:
filtering the patient safety database in accordance with the criteria to obtain a subset of patient safety data records in the patient safety database and performing any one or more of:
presenting at least some of the fields of the subset in the first output format for inclusion within a listing user interface displayed to the user; and
displaying a statistical summary of the subset;
responsive to a third system user input indicative of a particular patient safety data record selected by the system user for reporting to a third party:
presenting, to a patient safety event reporting module, at least some of the fields of the particular patient safety data record in a second output format suitable for inclusion within a patient safety event report format specified by the third party.

2. The method of claim 1, wherein the remote inputs comprise non-textual inputs selected from:
voice inputs indicative of voice information provided to the patient safety application by a microphone of the mobile device;
bar code inputs, indicative of bar code information corresponding to an image of a bar code provided to the patient safety application by a camera of the mobile device;
radio frequency inputs, indicative of a radio frequency identifier detected by the mobile device;
menu selection inputs indicative of a user interface menu object selected by the mobile device user;
image inputs indicative of an image captured by or stored in the mobile device; and
video inputs indicative of video captured by or stored in the mobile device.

3. The method of claim 2, wherein a particular remote input comprises a voice input and wherein automatically populating at least some of the fields in the patient safety data record includes accessing a speech-to-text processing resource to obtain a text representation of speech included in the voice input.

4. The method of claim 2, wherein a particular remote input comprises a bar code input and wherein automatically populating at least some of the fields in the patient safety data record includes providing the bar code information to an external database and obtaining records associated with the bar code information.

5. The method of claim 4, wherein the bar code comprises a patient identification bar code identifying the patient and the external database comprises a master patient indexer.

6. The method of claim 5, wherein the records associated with the bar code information include electronic health records of the patient.

7. The method of claim 4, wherein the bar code information identifies a medication administered to the patient and wherein the records associated with the bar code information include dosage alternatives appropriate for the medication and wherein the patient safety system operations include, providing the dosage alternatives, via the patient safety net, to the patient safety application for display to and selection by the mobile device user.

8. The method of claim 4, wherein the bar code information identifies a medical device and wherein the records associated with the bar code information include information pertaining to operation and maintenance of the medical device.

9. The method of claim, 1 the remote input indicating a patient safety event category comprises remote input indicating one of a set of predetermined patient safety event types specified by a third party and one of a set of patient safety event levels specified by a third party.

10. The method of claim 1, wherein:
the set of patient safety event types includes: a medication event type, a DVT/PE event type, an anesthesia-surgery event type, a hospital infection event type, a pressure ulcer event type, a fall event type, a medical device event type, a blood and blood product event type, and a perinatal event type; and
the set of patient safety event levels includes: an incident level, a near miss level and an unsafe condition level.

11. The method of claim 1, wherein the operations include:
responsive to a fourth system user input, providing a particular patient safety data record to a peer review group; and
responsive to peer review group input, including peer review finds and recommendations within corresponding fields of the patient safety data record.

12. The method of claim 1, wherein presenting fields of the particular patient safety data record for inclusion within the patient safety event report format includes excluding from the patient safety event report, information identifying the patient or a care giver who provided care to the patient.

13. A mobile device, comprising:
a processor;
a radio frequency transceiver configured for enabling communication with a remote server via a wireless patient safety network;
a touch screen display for displaying information to the user and receiving touch input from the user;
a memory device including processor executable patient safety application instructions that, when executed by the processor, cause the mobile device to perform operations comprising:
prompting the user to provide login credentials input and granting access to the user responsive to verifying the login credentials;
prompting the user to identify a patient safety event category;
responsive to receiving input identifying the patient safety event category, performing operations including:
wirelessly transmitting the patient safety event category to a patient safety system via a patient safety network; and
presenting a set of fields corresponding to the patient safety event category to the mobile device user;
responsive to receiving a particular input indicative of particular information corresponding to a particular field, wirelessly transmitting the particular information to the patient safety system via the patient safety network;
responsive to receiving an input indicating completion:
verifying completion of a minimum set of the fields presented to the user;
transmitting information corresponding to the completed fields to the patient safety system; and
clearing the mobile device of any information provided to the patient safety system.

14. The mobile device of claim 13, wherein the operations include:
establishing a connection with a wireless access point supporting at least a portion of the patient safety network, wherein establishing the connection includes providing input identifying the patient safety network and input indicative of a patient safety network password.

15. The mobile device of claim 14, wherein providing the input indicative of the patient safety network password includes either providing user input indicative of the patient safety network password or providing user input indicative of a seed generated by the mobile device and displayed to the user.

16. The mobile device of claim 13, wherein receiving the user inputs includes receiving bar code inputs indicative of a bar code scanned by a camera of the mobile device.

17. The mobile device of claim 16, wherein the bar code inputs indicate at least one: an identity of a patient, a medication or blood product administered to the patient, a medical device used in conjunction with the patient.

18. The mobile device of claim 13, wherein the operations include, responsive to sending particular information identifying the patient to the patient safety system, receiving electronic medical records associated with the patient safety system.

19. The mobile device of claim 13, wherein the operations include, responsive to providing particular information identifying a particular medication, receiving administration options for the medication and displaying a selectable menu of the administration options to the mobile device user.

20. A patient safety system, comprising:
a processor;
a computer readable memory, including processor executable instructions that, when executed by the processor, cause the processor to perform operations comprising:
providing a patient safety application to a mobile device of a mobile device user;
receiving remote inputs wirelessly transmitted by the mobile device over a patient safety network, wherein the remote inputs are indicative of information obtained by the patient safety application pertaining to a patient safety event;
responsive to receiving remote input indicating a patient safety event category, creating a patient safety data record, comprising a set of fields, corresponding to the patient safety event;
responsive to receiving a subsequent remote input wirelessly transmitted over the patient safety network by the mobile device, automatically populating at least some of the fields in the patient safety data record with values determined in accordance with the subsequent remote input;
storing the patient safety data record in a transformation agnostic patient safety database;
responsive to a first user input indicative of a particular patient safety data record:
providing at least some of the fields in the particular patient safety record in a first output format suitable for inclusion within a patient safety data record user interface displayed to the user; and
responsive to a user input modifying an element of the user interface, modifying a corresponding field in the patient safety data record;
responsive to a second administrator input indicative of criteria:
filtering the patient safety database in accordance with the criteria to obtain a subset of patient safety data records in the patient safety database and performing any one or more of:
presenting at least some of the fields of the subset in the first output format for inclusion within a listing user interface displayed to the user; and
displaying a statistical summary of the subset;
responsive to a third system user input indicative of a particular patient safety data record selected by the system user for reporting to a third party:
presenting, to a patient safety event reporting module, at least some of the fields of the particular patient safety data record in a second output format suitable for inclusion within a patient safety event report format specified by the third party.
